(19) United States
(12) Patent Application Publication
(10) Pub. No.: US 2026/0289708 A1
(43) Pub. Date: Sep. 24, 2026

(54) SYSTEM

(71) Applicant: SoftBank Group Corp., Tokyo (JP)

(72) Inventor: Kota TAKEDA, Tokyo (JP)

(73) Assignee: SoftBank Group Corp., Tokyo (JP)

(21) Appl. No.: 19/558,605

(22) Filed: Mar. 6, 2026

(30) Foreign Application Priority Data
Mar. 19, 2025 (JP) 2025-044526

(51) Int. Cl. G06Q 50/20; G06F 40/211; G06N 3/0475

(52) U.S. Cl. CPC G06Q 50/20; G06F 40/211; G06N 3/0475

(57) ABSTRACT

A system includes a processor, wherein the processor is configured to: receive a communication notebook content from a guardian, analyze a received content and generate a prompt for instructing a generative AI model to generate a draft reply text, and present a draft reply text received from the generative AI model to a teacher terminal.

### CROSS-REFERENCE TO RELATED APPLICATION

This application is based on and claims priority under 35 USC 119 from Japanese Patent Application No. 2025-044526 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In schools and other educational institutions, teachers are required to communicate frequently with guardians through communication notebooks or similar channels. This communication often involves sensitive topics related to students' academic performance, behavioral issues, health conditions, and family circumstances. As a result, teachers must carefully draft reply messages that are accurate, empathetic, and appropriately tailored to the emotional state of the guardians. However, the process of reading each message from a guardian, considering the guardian's emotions, and drafting a thoughtful and trust-building reply is time-consuming and increases the workload of teachers, who are already burdened with many other educational and administrative tasks.

Furthermore, if a reply is drafted in a hurried or inconsistent manner, there is a risk that the content may not sufficiently reassure the guardian or may even cause misunderstanding or anxiety, thereby undermining trust between the school and the guardian. Conventional systems that merely provide template-based replies or simple text editing support are inadequate because they do not sufficiently consider the nuanced emotional state of guardians and do not effectively support teachers in generating personalized and empathetic responses.

Accordingly, there is a need for a system that can assist teachers in efficiently generating high-quality reply drafts to guardians'messages, while taking into account the guardians'emotional state so as to enhance reassurance and trust, and at the same time allowing teachers to retain control over the final content of the communication.

### SUMMARY

In order to solve the above-described problems, a system according to one embodiment of the present invention comprises a processor configured to receive communication notebook content from a guardian, to analyze the received content, and to generate a prompt for instructing a generative AI model to generate a draft reply text. By automatically generating the prompt based on the analysis of the guardian's message, the processor can cause the generative AI model to produce a reply draft that is contextually appropriate to the specific content of the guardian's communication.

The processor is further configured to take into account an emotional state of the guardian at a time of prompt generation so that the draft reply text generated by the generative AI model includes content that increases reassurance and a degree of trust of the guardian. For example, the processor may estimate, from the wording and expressions used in the guardian's message, whether the guardian is anxious, dissatisfied, or seeking clarification, and reflect such emotional state as conditions or instructions within the generated prompt. As a result, the generative AI model is guided to produce reply drafts that are not only factually accurate but also empathetic and supportive of the guardian's emotional needs.

Additionally, the processor is configured to provide an output of the generative AI model in an editable format for a teacher, and to present the draft reply text to a teacher terminal. The teacher can review, modify, and approve the AI-generated draft before sending it to the guardian. By enabling such editing, the system allows teachers to adapt the draft to individual communication styles and specific school policies, while still benefiting from reduced drafting time. Through this configuration, the system shortens the working time required to respond to guardians and maximizes communication effectiveness by combining AI-assisted draft generation with teacher oversight and customization.

The term “system” refers to a combination of hardware and software components that cooperate to execute the processing defined in the claims, including at least one processor and, optionally, storage devices, communication interfaces, and terminals used by teachers or guardians.

The term “processor” refers to one or more hardware processing units, such as a CPU, GPU, or dedicated AI accelerator, and may also encompass a plurality of such units operating together, configured by software or firmware to execute the functions specified in the claims.

The term “communication notebook content” refers to textual or multimedia information that a guardian submits to a school or teacher for purposes of reporting, inquiry, consultation, or communication regarding a student, including but not limited to messages, notes, and questions.

The term “guardian” refers to a parent, legal guardian, or other person who is responsible for the care and oversight of a student and who communicates with a teacher or educational institution regarding that student.

The term “analyze” refers to performing processing on input data, such as parsing, classification, sentiment analysis, keyword extraction, or context determination, in order to derive information used for subsequent processing steps including prompt generation.

The term “prompt” refers to a structured input, instruction, or query provided to a generative AI model, including natural language text and optionally metadata or control parameters, that guides the generative AI model in producing a desired output such as a draft reply text.

The term “generative AI model” refers to a machine learning model, such as a large language model, trained to generate natural language text or other content in response to input prompts, and capable of producing context-sensitive and coherent reply drafts.

The term “draft reply text” refers to a provisional response message generated by the generative AI model based on a prompt, which is intended to be reviewed, optionally edited, and then used as or incorporated into a final reply to a guardian.

The term “teacher terminal” refers to an electronic device operated by a teacher, such as a personal computer, tablet, or smartphone, configured to display the draft reply text and to allow the teacher to review, edit, and manage communications with guardians.

The term “emotional state of the guardian” refers to an inferred or estimated condition of the guardian's feelings, such as anxiety, concern, dissatisfaction, relief, or trust, derived from the language, expressions, or context present in the guardian's communication.

The term “reassurance” refers to a quality of the reply text that alleviates or reduces a guardian's anxiety, concern, or uncertainty regarding a student or a situation, and that provides a sense of comfort or security.

The term “degree of trust” refers to a level of confidence or belief that a guardian has in the teacher or educational institution, which can be influenced by the clarity, empathy, consistency, and reliability of reply messages.

The term “editable format” refers to a representation of the draft reply text that allows a teacher to modify, delete, or add content using an input interface on the teacher terminal before the reply is finalized and transmitted to the guardian.

The term “working time” refers to an amount of time spent by a teacher on job-related tasks, including reading messages from guardians, drafting responses, and managing communication, and is intended to be reduced by use of the system.

The term “communication effectiveness” refers to the overall quality and impact of exchanges between teachers and guardians, including clarity of information, emotional appropriateness, mutual understanding, and contribution to maintaining or improving the relationship and cooperation between the parties.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

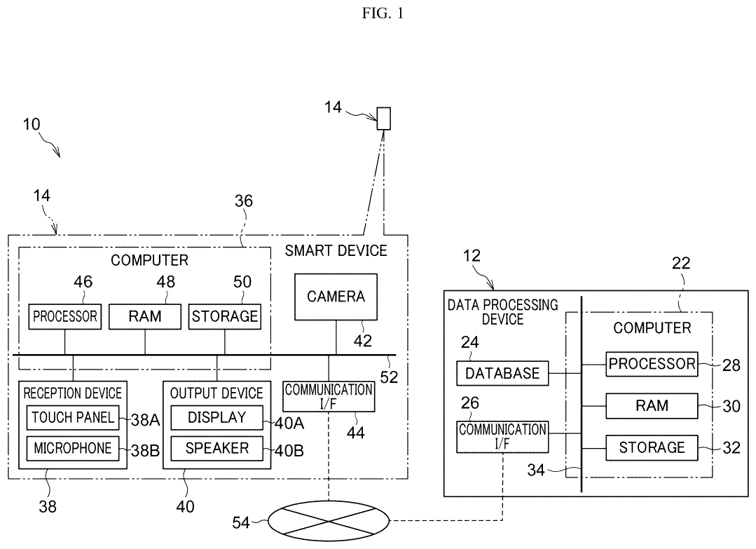

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

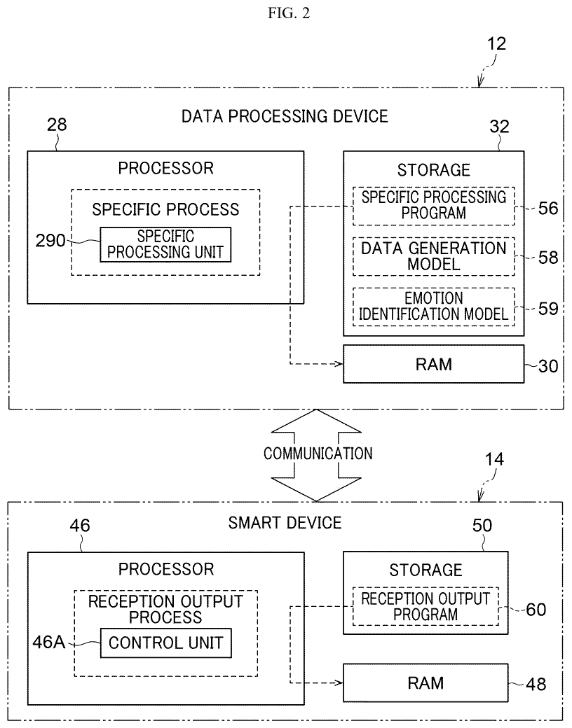

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional computer-implemented task management and communication support systems, natural-language instructions provided by users are typically handled in an ad hoc or rule-based manner. Such systems often rely on fixed templates or manually crafted workflows that map a limited set of input patterns to predefined operations. As a result, these systems exhibit several technical drawbacks.

First, when a user issues a compound natural-language instruction that implicitly contains multiple work tasks, conventional systems frequently fail to decompose the instruction into appropriately structured task information. This leads to either incomplete execution of requested tasks, redundant queries back to the user, or the need for human operators to manually interpret and configure task flows. Consequently, the computing resources in the system, such as processors, storage devices, and communication interfaces, are not efficiently utilized because the system is unable to automatically and robustly interpret complex natural-language input.

Second, even when a system includes a generative AI model, the use of such a model is often limited to producing surface-level text outputs, such as email drafts, without integrating the model into a deeper, structured orchestration of back-end information processing resources. In such architectures, the generative AI model is typically invoked as an isolated text generator, and there is no standardized mechanism to generate prompt sentences that cause the generative AI model to output machine-usable structured data. This results in additional parsing overhead, error-prone post-processing, and increased latency, which degrade system performance and reliability from a computer-technology standpoint.

Third, existing systems generally do not coordinate calendar access, participant extraction, and communication transmission in a unified, automatically prioritized workflow driven by generative AI outputs. They tend to treat calendar services and communication services as separate subsystems, loosely integrated through manual scripting or user actions. This siloed architecture impairs the ability of the processor to determine an optimal execution order for multiple tasks based on importance or urgency, and increases the number of round trips between the user terminal and the server. Such increased interactions and fragmented processing negatively affect throughput, responsiveness, and scalability of the overall computer system.

Fourth, many systems do not provide a structured mechanism for the server to generate human-readable summary information about tasks actually executed, nor do they effectively close the loop between automatic processing and user confirmation or correction. Without this feedback-oriented, summary-generating mechanism, the user must manually inspect scattered logs or interfaces, which increases cognitive load and reduces the practical effectiveness of the computing system in automating daily work.

Accordingly, there is a need for an improved computer-implemented system and method that: (i) systematically converts natural-language work instructions into structured task information using a generative AI model driven by carefully constructed prompt sentences; (ii) tightly integrates this structured task information with time management resources and communication resources under control of a processor; (iii) determines and executes an appropriate order of multiple tasks based on importance and urgency; and (iv) generates and presents natural-language summary information about executed processing. By addressing these issues at the system architecture and processing-flow level, it becomes possible to improve the operation of the computer itself, including task interpretation accuracy, resource utilization, processing efficiency, and user interaction efficiency in a technical sense.

The specific processing by the specific processing unit 290 of the data processing device 12 in Example 1 is realized by the following means.

The present invention provides a server comprising a processor and at least one memory storing instructions that, when executed by the processor, cause the processor to receive, via a terminal, a work instruction expressed in natural language from a user and store the work instruction in a data storage; analyze the work instruction to generate, based on an analysis result, a first prompt sentence that instructs a generative AI model to convert the work instruction into structured task information representing at least one work task; transmit the first prompt sentence to the generative AI model and obtain, from the generative AI model, the structured task information generated in response to the first prompt sentence; acquire schedule information from a time management information processing resource by using the structured task information as input and extract meeting information and participant information from the schedule information; generate, based on the meeting information and the participant information, a second prompt sentence that instructs the generative AI model to generate a meeting invitation communication text, and transmit the second prompt sentence to the generative AI model to obtain a draft of the meeting invitation communication text; cause, by using a communication processing information resource, transmission of a meeting invitation communication to participants on the basis of the draft of the meeting invitation communication text and store a transmission result in the data storage; and generate, based on the transmission result, result information that represents in natural language a summary of work processing executed by the server and cause the result information to be presented on the terminal. This enables a computer-implemented system to automatically and reliably transform natural-language work instructions into structured, multi-step task executions coordinated across calendar resources and communication resources under control of the processor, to determine and perform appropriate operations with reduced user intervention, and to enhance overall system performance and usability by improving task interpretation accuracy, resource utilization efficiency, and response latency in a technically integrated manner.

The term “work instruction” refers to information expressed in natural language by a user, indicating one or more operations, actions, or tasks that the user desires a computer system to perform.

The term “terminal” refers to an information processing apparatus, such as a client device, that provides a user interface for inputting and outputting information and that communicates with a server over a communication network.

The term “server” refers to an information processing apparatus, or a group of such apparatuses, that provides computing resources, storage resources, and communication control for processing work instructions received from one or more terminals.

The term “processor” refers to one or more hardware processing units, such as a central processing unit or a graphics processing unit, that execute instructions stored in a memory to perform logical operations, data processing, and control of other components.

The term “memory” refers to one or more hardware storage units, such as volatile memory or non-volatile memory, that store instructions and data used by the processor during execution of programs.

The term “data storage” refers to a storage resource, such as a database or file storage system, used to persistently or semi-persistently store work instructions, structured task information, schedule information, communication texts, and processing results.

The term “natural language” refers to a human language used for everyday communication, such as spoken or written sentences, as opposed to a formal programming language or command language.

The term “generative AI model” refers to an information processing model, such as a machine learning model or a neural network model, configured to generate output data including text in response to input data, and capable of processing natural-language input through techniques including natural language processing.

The term “prompt sentence” refers to text or structured data provided as input to a generative AI model, the text or data specifying instructions, conditions, or context that cause the generative AI model to perform a particular generation processing.

The term “structured task information” refers to machine-readable data that represents one or more work tasks in a structured format, such as fields or records indicating actions, targets, time ranges, or related resources derived from a natural-language work instruction.

The term “time management information processing resource” refers to a hardware and software combination, such as a scheduling system or calendar management system, that stores and provides access to schedule information including events, time slots, and related metadata.

The term “schedule information” refers to data representing temporal arrangements, events, or appointments associated with a user, including information such as dates, times, subjects, locations, and participant data.

The term “meeting information” refers to schedule information for one or more events that correspond to meetings, including at least a meeting time, a meeting subject, a meeting location, and identifiers of participants.

The term “participant information” refers to data identifying persons or entities that are expected to attend a meeting, including identifiers such as names, addresses, or communication endpoints.

The term “communication processing information resource” refers to a hardware and software combination, such as an electronic mail sending system or a message transmission system, that sends and receives communication data over a communication network.

The term “meeting invitation communication text” refers to text content of a communication to be sent to participants, the text inviting the participants to attend a meeting and including information regarding at least a time, a location, or a subject of the meeting.

The term “draft of the meeting invitation communication text” refers to a preliminary version of a meeting invitation communication text generated by the generative AI model before final approval or modification by a user.

The term “transmission result” refers to information indicating a status of sending a communication, including success, failure, or related identifiers and timestamps for each attempted transmission.

The term “result information” refers to natural-language text describing a summary of one or more work tasks executed by the server, including at least an outline of operations performed and outcomes obtained.

The term “importance level” refers to a parameter or value associated with a work task that indicates a relative weight, significance, or priority of the work task in comparison with other work tasks.

The term “urgency level” refers to a parameter or value associated with a work task that indicates a time-critical degree or required promptness for execution of the work task in comparison with other work tasks.

The term “execution order” refers to a sequence in which a plurality of work tasks are to be executed, the sequence being determined based on at least one of an importance level or an urgency level of each work task.

The term “editable format” refers to a representation of text or data that allows a user, via a terminal, to modify the content by operations such as insertion, deletion, or replacement prior to final transmission or storage.

The term “user” refers to a person or an entity that interacts with the terminal to input work instructions, review processing results, and optionally approve or modify communication texts.

In one embodiment, a server implements the claimed system by executing computer programs on one or more hardware processing units. The server includes at least one central processing unit and, in some cases, at least one graphics processing unit used for neural network inference. The server operates under a general-purpose operating system such as a server-type operating system, and uses a web application framework such as a scripting-language-based framework or a virtual-machine-based framework. The server further uses a database management system, a calendar management service interface, and an electronic communication service interface.

The terminal operates as a client device, such as a smartphone, a tablet, or a personal computer, and executes a client application or a web browser. The terminal presents a user interface for a user to input natural-language work instructions and to view processing results returned from the server. The terminal communicates with the server through a communication network such as the Internet by means of a secure communication protocol. The terminal may include an operating system-level speech recognition component to convert spoken language into text prior to transmission to the server.

The user provides, via the terminal, a work instruction in natural language. The user may type text into an input field or may utter a spoken instruction that is converted to text by the terminal. The terminal encapsulates the text instruction with an identifier of the user and sends it to the server over a network connection. The server stores the received work instruction in a persistent data storage, such as a relational database, together with metadata including a timestamp, a user identifier, and a request identifier. This stored data provides a stable input for subsequent processing and enables reproducibility and auditability of the processing flow.

The server analyzes the received work instruction by executing a program that first performs syntactic and semantic preprocessing. The server uses a natural-language preprocessing module, which may include tokenization, sentence segmentation, normalization, and language detection. The server may use well-known software libraries such as a general-purpose natural-language toolkit or a machine-learning inference library. The output of this preprocessing is a sequence of tokens and associated features, such as part-of-speech tags and dependency relations.

The server generates a first prompt sentence to a generative AI model based on the preprocessed work instruction. The server composes the first prompt sentence as a concatenation of a system instruction portion and a user instruction portion. The system instruction portion defines how the generative AI model should output structured task information, and the user instruction portion contains the content of the work instruction. For example, the server may generate the following first prompt sentence:

“You are a task parser. Analyze the following user instruction and output a list of tasks in a structured format with fields: action, target_date, time_range, and resources. User instruction: ‘Check today's schedule and send invitation emails for the necessary meetings.’”

The server transmits the first prompt sentence to a generative AI model. In one embodiment, the generative AI model is a transformer-based neural network including a multi-layer self-attention architecture with an encoder-decoder structure or a decoder-only structure. The generative AI model may be implemented by a large language model comprising a plurality of layers, each layer including multi-head attention sublayers, feed-forward sublayers, normalization layers, and residual connections. The server executes the generative AI model on hardware accelerators, such as graphics processing units, using a deep-learning runtime environment. The server sends the tokenized representation of the first prompt sentence, together with model configuration parameters such as a temperature parameter and a maximum output length, to the generative AI model.

The server causes the generative AI model to perform inference. During inference, the generative AI model computes, for each token position, attention scores over previous tokens, multiplies such scores by key and value vectors, and aggregates results through linear transformations. The generative AI model generates output tokens representing structured task information, such as textual representations of action types, dates, and time ranges. The model internally uses learned weight matrices that were previously optimized by a training process using a large corpus of natural-language instructions and corresponding structured annotations. The training process may employ a cross-entropy loss function between predicted token sequences and ground-truth sequences, with weight updates computed by backpropagation and gradient-based optimization such as stochastic gradient descent with adaptive learning rate. The server, however, in this embodiment, uses the model only in an inference mode and does not modify model weights at run time.

The server receives the output token sequence from the generative AI model and converts it into structured task information. The server parses the output according to predefined delimiters or field markers. The server maps textual labels such as “check_schedule” and “send_meeting_invitations” into internal action codes and converts relative expressions such as “today” into an absolute date based on a time zone associated with the user. The server stores the structured task information in the data storage as records including fields for action type, target date, time range, and resource identifiers. By storing structured task information in this manner, the server enables subsequent modules to operate on well-defined, machine-readable data, improving processing speed and avoiding repeated natural-language parsing.

The server acquires schedule information from a time management information processing resource. In one embodiment, the server connects to a calendar management service via an application programming interface. The server retrieves an access token corresponding to the user from a secure credential store and issues a query to the calendar management service specifying a start time and an end time derived from the structured task information. The calendar management service returns schedule information as records containing event identifiers, event titles, start times, end times, locations, and participant identifiers. The server stores this schedule information locally in a temporary data structure and may also cache it in the database for performance improvement.

The server extracts meeting information and participant information from the schedule information by applying filtering and transformation algorithms. The server identifies events categorized as meetings by using criteria such as the presence of at least one participant other than the user and event types indicating a meeting category. The server builds a list of meeting information objects that include normalized time ranges, standardized location descriptions, and arrays of participant information including names and communication addresses. The server may further call a directory service to resolve display names and departmental attributes corresponding to participant addresses. This normalization process reduces variability in the input to subsequent modules and decreases the likelihood of errors in communication generation.

The server generates, based on the meeting information and the participant information, a second prompt sentence for the generative AI model to create a meeting invitation communication text. The server combines a system instruction that specifies a desired tone, language, and format with the specific meeting details. For example, the server may generate the following second prompt sentence:

“You are an assistant that writes professional meeting invitation emails in English. Use the following meeting information and output only an email subject and an email body in plain text, suitable for sending as an invitation. Meeting information: title ‘Project Kickoff’, date ‘2026-02-01’, start time ‘10:00’, end time ‘11:00’, location ‘Online’, participants ‘alice@example.com’, ‘bob@example.com’. Tone: formal.”

The server transmits the second prompt sentence to the generative AI model. The generative AI model processes the second prompt sentence using the same transformer-based architecture and generates an output sequence representing an invitation subject and body. Internally, the model attends to tokens corresponding to meeting title, times, location, and participants, and outputs phrases that coherently describe a meeting invitation. Because the model has been pre-trained and optionally fine-tuned on large corpora of communication texts and instructions, the generated output tends to be grammatically correct and contextually coherent. The server receives the output and segments it into a subject portion and a body portion using predefined markers or pattern matching.

The server constructs a message object suitable for the communication processing information resource. In one embodiment, the communication processing information resource is an electronic mail sending system accessible via an application programming interface or via a message transmission protocol. The server populates header fields such as sender address, recipient addresses, subject, and encoding type, and sets the body content to the generated invitation text. The server may convert line endings and character encodings to match the requirements of the communication processing information resource. The server also records a mapping from event identifiers to generated message identifiers in the database, enabling future tracking and prevention of duplicate message generation.

The server causes transmission of the meeting invitation communication via the communication processing information resource. The server sends the constructed message object through a network connection to the communication processing information resource and receives acknowledgments or error codes indicating success or failure for each recipient. The server writes the transmission result, including status, timestamps, and error details, into the data storage. This explicit logging supports robust error handling and allows the server to implement retry mechanisms in case of transient failures, thereby improving reliability and reducing message loss rates.

The server generates result information representing in natural language a summary of the work processing executed. The server forms an internal representation of the actions performed, including the number of meetings processed, the number of invitations sent, and any errors encountered. The server may optionally employ the generative AI model again with a third prompt sentence designed for summarization, such as:

“You are an assistant that summarizes system actions for the user. Summarize, in one or two sentences, the following actions: checked today's schedule, identified two meetings, and sent invitations to four participants.”

The server receives a concise natural-language summary and stores it as result information. The server then sends the result information to the terminal, which displays it in a human-readable form, allowing the user to quickly verify that the intended operations were executed.

In one embodiment, the server determines an execution order among multiple work tasks contained in the structured task information. The server assigns each task an importance level and an urgency level based on attributes such as task type, deadlines obtained from schedule information, and user preferences stored in the database. The server computes a composite priority score using a predetermined algorithm, for example a weighted sum of normalized importance and urgency values. The server then orders tasks by this priority score and executes them in that order. By performing this algorithmic prioritization, the server reduces contention for limited processing and communication resources, thereby lowering average response time and avoiding bottlenecks when many tasks are requested concurrently.

In another embodiment, the server presents the generated draft of the meeting invitation communication text in an editable format on the terminal. The server returns the draft to the terminal along with structured fields, such as subject and body, that can be directly edited in a client user interface component. The user may modify the text by adding specific details or adjusting wording. The terminal sends the modified text back to the server, which then uses the modified text instead of the original draft as the body of the communication to be transmitted. This interaction reduces the need for the user to compose messages from scratch while still allowing human oversight, and it avoids additional re-parsing of free-form user text by the server.

From a technical perspective, the described architecture improves computer technology beyond mere automation of human tasks. The server uses the generative AI model not only to produce surface text but also to produce structured task information that interfaces directly with calendar and communication subsystems. This structured representation reduces the amount of rule-based parsing logic that would otherwise be required, decreasing code complexity and execution time. The use of prompt sentences tailored to extract structured output from the generative AI model results in fewer misinterpretations and higher accuracy of task decomposition, which in turn reduces the number of corrective interactions between the user and the system. Because the generative AI model performs inference with optimized matrix operations on hardware accelerators, the conversion of complex natural-language instructions into structured data occurs with lower latency than would be achievable with manually engineered rule-based parsers.

Furthermore, the server's prioritization mechanism, which integrates importance and urgency levels into a computed execution order, reduces redundant access to external services. For example, by grouping calendar queries for multiple tasks into consolidated time ranges, the server decreases the number of network calls to calendar services. Similarly, by batching message transmissions where appropriate, the server reduces the number of separate communication sessions with the communication processing information resource. These reductions in external calls lower network traffic and decrease total processing time, providing a concrete improvement in communication efficiency and system throughput.

The generative AI model itself is implemented as a multi-layer neural network trained with large-scale training data. During training, the model minimizes a loss function computed between predicted sequences and target sequences containing correct structured outputs or correctly formatted communication texts. The training uses gradient-based optimization with regularization techniques such as dropout and weight decay to prevent overfitting. Data augmentation techniques, such as paraphrasing or varying formats of date expressions, are used to expose the model to a variety of input styles, increasing its robustness. As a result of this specialized training, the model acquires an ability to normalize diverse natural-language expressions into a uniform internal representation, which, when deployed within the server, yields improved consistency and reduced error rates in task interpretation compared to conventional keyword-based matching systems.

The server applies specific non-conventional rules in constructing prompt sentences and interpreting outputs. For example, the server enforces a rule that all structured outputs must adhere to a predefined set of action labels and field names, and the server rejects or re-prompts outputs that do not match this schema. This closed-world constraint differs from typical generative use where arbitrary text is accepted. By imposing these constraints and re-invoking the generative AI model with correction prompts if needed, the server achieves a self-stabilizing behavior that constrains the generative process toward a machine-usable format. This technique reduces ambiguity and limits propagation of errors into downstream modules.

In another embodiment, the server executes alternative generative AI models depending on resource availability and required accuracy. The server may select a smaller, faster model when low latency is required, and a larger, more accurate model when the complexity of the work instruction is high. The server maintains latency and accuracy statistics for past invocations and updates selection thresholds based on these statistics. This adaptive model selection further improves overall response time and resource utilization in the computing environment.

In yet another embodiment, the server may host the generative AI model locally or may access the model as a service provided by a remote system. When the model is hosted locally, the server leverages a compute cluster with multiple processing nodes connected by a high-speed interconnect and uses a distributed inference engine to partition and parallelize computation across devices. When the model is accessed as a remote service, the server employs caching of prompt-output pairs or partial outputs for common instruction patterns to avoid repeated full-scale inference. These variations further demonstrate that the invention is implemented as a concrete improvement of computer systems, not merely as a conceptual workflow.

The terminal may also implement variations. In one variation, the terminal pre-filters user input by offering suggested work instruction templates, which reduces the complexity of text sent to the server. In another variation, the terminal provides offline storage of recently retrieved result information so that the user can access summaries without re-querying the server, thereby reducing network usage.

As described above, the server, the terminal, and the user cooperate to realize the claimed system. The server performs detailed, structured processing of natural-language work instructions using a generative AI model guided by specifically designed prompt sentences, integrates the resulting structured information with external time management and communication resources, and returns informative summaries to the user. Because this processing reduces processing ambiguity, improves scheduling and transmission efficiency, and optimizes utilization of computing and communication resources, the system produces technical effects such as increased processing speed, improved accuracy of task identification, reduced error rates in communication generation, reduced network load, and improved scalability of the underlying computing infrastructure.

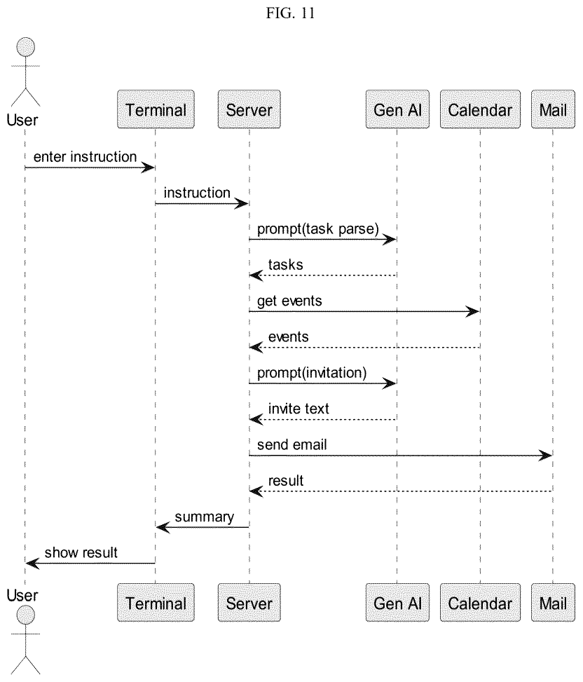

The following describes the processing flow using FIG. 11.
Step 1:

The user inputs a work instruction in natural language on the terminal.

The terminal displays an input field, receives text typed by the user or speech captured by a microphone, and, if speech is used, converts the audio signal into text using a speech recognition function.

Input: acoustic signal or character string entered by the user.

Output: a normalized character string representing the work instruction, such as “Check today's schedule and send invitation emails for the necessary meetings.”

The terminal encodes the character string with a user identifier and a timestamp and prepares a request payload.
Step 2:

The terminal transmits the work instruction to the server.

The terminal opens a secure network connection, for example using HTTPS, and sends a structured request including the user identifier and the natural-language work instruction to a predefined application programming interface endpoint on the server.

Input: the normalized work instruction string and user metadata.

Output: a network message containing the work instruction delivered to the server.
Step 3:

The server receives and stores the work instruction.

The server accepts the network message, verifies authentication tokens, and parses the request body to extract the user identifier and the work instruction string. The server writes a record into a database table including the work instruction, the user identifier, and a request identifier generated by the server.

Input: the network message from the terminal.

Output: a stored database record representing the raw work instruction and associated metadata.
Step 4:

The server preprocesses the work instruction for natural-language analysis.

The server applies a natural-language preprocessing module that performs operations such as tokenization, lowercasing, and removal of extraneous whitespace. The server may also detect the language and annotate tokens with part-of-speech tags.

Input: the raw work instruction string from the database record.

Output: a sequence of tokens and associated linguistic features stored in a transient data structure, which is used as an intermediate representation for prompt generation.
Step 5:

The server generates a first prompt sentence for a generative AI model to obtain structured task information.

The server concatenates a system instruction segment and the original work instruction into a single text string. For example, the server generates:

“You are a task parser. Analyze the following user instruction and output a list of tasks with fields: action, target_date, time_range, and resources. User instruction: ‘Check today's schedule and send invitation emails for the necessary meetings.’”

The server uses string processing to insert the user's original instruction into a predefined template.

Input: the original work instruction string and a stored prompt template.

Output: a first prompt sentence formatted as a single text string ready to be sent to the generative AI model.
Step 6:

The server invokes the generative AI model with the first prompt sentence and receives structured task information.

The server tokenizes the prompt sentence into token identifiers and sends these identifiers to the generative AI model via an inference interface. The generative AI model, implemented as a multi-layer transformer network, computes attention scores, multiplies them with key and value vectors, and propagates activations through feed-forward layers to generate output tokens that represent structured task information.

Input: the first prompt sentence string and model configuration parameters (such as maximum output length and temperature).

Output: a generated text sequence describing structured task information, for example a list of tasks with labels like “check_schedule” and “send_meeting_invitations,” which the server then captures as a character string.
Step 7:

The server parses the model output into internal structured task information.

The server applies a parsing routine to the generated text, splitting it into individual task descriptions and extracting field values for action types, target dates, and time ranges. The server converts relative expressions such as “today” into absolute dates by querying a user profile that stores the user's time zone and current date offset.

Input: the generated text sequence from the generative AI model.

Output: structured task information stored as records or objects, each containing normalized fields such as action code, target date-time range, and required resources.
Step 8:

The server determines an execution plan based on the structured task information.

The server examines all extracted tasks, assigns each task an importance level and an urgency level using rules based on task type and deadlines, and computes a priority score for each task. The server then sorts the tasks by priority score to create an ordered execution plan.

Input: the set of structured task records.

Output: an ordered list of tasks with associated priority scores and any dependencies, stored in memory for subsequent processing.
Step 9:

The server queries a time management information processing resource to acquire schedule information.

For tasks that involve schedule checking, the server constructs a query specifying the relevant time range, such as the start and end of the current day. The server retrieves user-specific access credentials from a secure store and sends a request to a calendar management interface. The calendar system returns schedule entries including event identifiers, start times, end times, locations, and participant data.

Input: the ordered task list, user identifier, and calculated time ranges.

Output: schedule information as a collection of event records in a uniform format for internal processing.
Step 10:

The server extracts meeting information and participant information from the schedule information.

The server filters the schedule entries to identify those that meet conditions for meetings, such as having at least one participant other than the user and an event category indicating a meeting. The server then constructs meeting information objects that include event identifiers, normalized time intervals, subject lines, location descriptors, and participant information such as names and communication addresses.

Input: the schedule information from the time management resource.

Output: a set of meeting information objects and associated participant information ready for communication generation.
Step 11:

The server generates a second prompt sentence for the generative AI model to create a meeting invitation communication text.

For each meeting information object, the server fills a prompt template that specifies the role of the generative AI model and the required output format. For example, the server may create a prompt sentence:

“You are an assistant that writes professional meeting invitation emails in English. Use the following meeting information and output an email subject and an email body in plain text. Meeting information: title ‘Project Kickoff’, date ‘2026-02-01’, start time ‘10:00’, end time ‘11:00’, location ‘Online’, participants ‘alice@example.com’, ‘bob@example.com’. Tone: formal.”

The server uses string concatenation and formatting functions to insert concrete meeting details into the template.

Input: the meeting information objects and a stored second prompt template.

Output: one or more second prompt sentences, each corresponding to a meeting, represented as text strings.
Step 12:

The server invokes the generative AI model with the second prompt sentences and obtains drafts of meeting invitation communication texts.

The server sends each second prompt sentence to the generative AI model and receives, for each, an output text that includes an invitation subject and body. The generative AI model processes the prompts using its transformer architecture, internally combining learned representations of the meeting context with learned patterns of formal invitation language.

Input: the second prompt sentences for each meeting.

Output: generated invitation texts, each containing a subject line and a body, captured as character strings by the server.
Step 13:

The server separates and formats the generated invitation texts for transmission.

The server parses each generated invitation text to identify the subject segment and the body segment, using predefined delimiters or formatting conventions described in the prompt. The server then encodes the text according to the character set required by the communication system and prepares message objects with appropriate header fields such as sender, recipients, and subject.

Input: the generated invitation text strings from the generative AI model and the participant information for each meeting.

Output: fully formed message objects ready to be passed to a communication processing information resource.
Step 14:

The server transmits the message objects via a communication processing information resource and records transmission results.

The server connects to an electronic communication interface and sends the message objects as communication requests. The communication interface returns status codes or message identifiers indicating success, failure, or partial delivery. The server logs these transmission results into the data storage along with references to the corresponding meeting information and the original work instruction.

Input: the formatted message objects and a connection to the communication processing information resource.

Output: transmission result records stored in the database, including status, timestamps, and any error codes.
Step 15:

The server generates result information summarizing executed processing.

The server aggregates the transmission results and the executed tasks, counts the number of meetings processed and invitations sent, and constructs an internal summary record. The server may optionally generate a third prompt sentence to the generative AI model, such as:

“You are an assistant that summarizes system actions for the user. Summarize the following actions in one or two sentences: checked today's schedule, identified two meetings, and sent invitations to four participants.”

The server sends this prompt to the generative AI model, receives a concise natural-language summary, and uses it as result information.

Input: the ordered task list, schedule information, meeting information, and transmission results.

Output: a natural-language summary string representing the overall outcome of the processing.
Step 16:

The server returns the result information to the terminal.

The server creates a response message including the natural-language summary and, optionally, structured data describing each processed meeting and corresponding status. The server sends this response message over the secure network connection back to the terminal associated with the user.

Input: the summary string and associated structured result data.

Output: a network response message containing the result information delivered to the terminal.
Step 17:

The terminal presents the result information to the user.

The terminal receives the response message, parses the summary string and any structured details, and displays them in the user interface. The terminal may show a simple text summary or a list of meetings with indicators showing whether invitations have been successfully sent.

Input: the response message from the server.

Output: a visual or textual representation of the result information on the display, enabling the user to confirm that the requested work instruction has been handled.
Step 18:

The user optionally reviews and adjusts generated invitation texts before final transmission in an alternative mode.

In a variation where edits are allowed prior to transmission, the server sends the generated draft texts to the terminal instead of immediately transmitting them to participants. The terminal displays the subject and body in editable fields, and the user modifies the text as desired. The terminal then returns the modified texts to the server. In this variation, the actual transmission occurs after this step using the modified content instead of the original draft.

Input: the draft invitation texts displayed on the terminal.

Output: modified invitation texts provided by the user as new character strings for the server to use in subsequent transmission processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional task-support systems deployed in workplaces, such as retail stores, educational institutions, and service facilities, typically rely on rule-based software components and static workflow engines. These systems are often designed around predefined operation flows and fixed user interfaces, and therefore lack flexibility in interpreting diverse natural language instructions issued by individual users. As a result, when users attempt to manage complex daily tasks such as schedule checking, resource monitoring, or communication drafting, they must manually translate their intentions into rigid menu operations or form inputs. This leads to increased cognitive load, fragmented workflows, and inefficient utilization of computational resources.

Furthermore, existing systems that integrate machine learning or natural language processing generally treat the generative model as an isolated component that produces free-form text. They do not provide a structured mechanism that links a generative AI model's interpretation of a natural language instruction to real-time data retrieval from operational data stores, such as schedule databases or inventory databases, and subsequent generation of actionable, structured outputs. In such architectures, the generative AI model may generate responses that are inconsistent with the latest operational data, and the server must perform ad-hoc post-processing, which increases processing latency and leads to unstable system behavior.

In addition, conventional client-server architectures do not maintain an individualized generative AI configuration for each user in a systematic manner. Without individualized model behavior and prompt control based on user attributes or past interaction history, the system cannot adapt its response strategy to the specific operational context, experience level, or preferences of each user. This results in generic responses that are insufficiently aligned with the user's work environment and do not effectively support decision-making or reduce the user's psychological burden.

Another technical problem arises in the orchestration of multiple computational components involved in processing a user's natural language instruction: capturing the instruction at a terminal, transforming it into a machine-processable prompt, driving a generative AI model, acquiring real-time structured data, and returning a response that is simultaneously machine-actionable and human-editable. Conventional systems often scatter these responsibilities across uncoordinated modules, which leads to increased network round trips, redundant computations, and difficulty in guaranteeing response consistency. This degrades overall system throughput and responsiveness when serving many concurrent users.

Therefore, there is a need for a computer-implemented technique and server architecture that (i) systematically allocates and manages an individual generative AI model configuration per user, (ii) converts natural language instructions into structured prompt sentences that directly govern both generative reasoning and data access operations, (iii) tightly couples the generative AI model's output with real-time acquisition and organization of work-related data from a database, and (iv) returns to the terminal a response in a format optimized for both immediate presentation and manual editing. By improving the way the processor coordinates the generative AI model, prompt construction, and database interaction, it becomes possible to enhance computational efficiency, reduce latency, and increase the reliability and usefulness of system-generated outputs for end users.

The specific processing by the specific processing unit 290 of the data processing device 12 in Application Example 1 is realized by the following means.

The present invention provides a server comprising a processor configured to allocate, in a storage resource, an individual generative AI model configuration corresponding to each user, to receive, from a terminal of a user, text data including a natural language instruction, to generate, based on the text data, a prompt sentence for input to the individual generative AI model, to transmit the prompt sentence to the individual generative AI model and obtain a generation result including at least one of a task execution plan or a response draft corresponding to content of the natural language instruction, to acquire, based on the generation result, work-related data including at least one of schedule information or resource state information from a real-time data store, to extract or organize the work-related data in accordance with the content of the natural language instruction, and to generate information presentable to the user based on the extracted or organized work-related data and the generation result and transmit the information to the terminal. This enables the computing system to technically improve the coordination between natural language understanding and back-end data operations by centralizing, within the server processor, the generation of prompt sentences, the control of user-specific generative AI behavior, and the structured retrieval and organization of real-time operational data, thereby reducing processing latency, avoiding redundant computations, and delivering consistent, context-appropriate outputs that are more efficiently consumable and editable by the user.

The term “system” refers to an arrangement of one or more computing devices, storage resources, communication interfaces, and software components that cooperate to perform information processing as described in the claims.

The term “processor” refers to one or more hardware processing units, such as a central processing unit or a processing core, configured to execute instructions to perform the functions recited in the claims.

The term “storage device” refers to any non-transitory computer-readable medium, including volatile memory and non-volatile memory, that is capable of storing programs, configuration data, model parameters, and user-related information for access by the processor.

The term “generative AI model” refers to a machine-implemented model configured to generate output data, including natural language text or structured data, in response to input data, based on parameters learned from training data.

The term “individual generative AI model” refers to a generative AI model or a generative AI model configuration that is associated with a particular user and is controlled or parameterized in a manner specific to that user.

The term “user” refers to a human operator, such as a worker, staff member, or other individual, who interacts with the system to request processing of tasks and to receive results. The term “terminal” refers to an electronic device used by the user, including a mobile device, a portable computing device, or a fixed client device, that is configured to transmit data to and receive data from the server.

The term “natural language instruction” refers to an instruction expressed in a human language, such as spoken or written language, that describes a task or request to be processed by the system.

The term “text data” refers to digital data representing characters, symbols, or strings, including a transcription of a natural language instruction, that can be processed as input by the processor and the generative AI model.

The term “prompt sentence” refers to text data generated by the processor for input to the generative AI model, the text data specifying at least one of a task description, context information, or formatting constraints used to control the behavior of the generative AI model.

The term “generation result” refers to output data produced by the generative AI model in response to a prompt sentence, including at least one of a task execution plan, a response draft, or other generated content.

The term “task execution plan” refers to structured information indicating one or more actions, queries, or processing steps to be performed by the system in response to a natural language instruction.

The term “response draft” refers to generated text that is intended to be presented to the user or to another party as a candidate message, explanation, or reply that may optionally be edited.

The term “work-related data” refers to data stored in an information resource that is used to support tasks or operations of the user, including at least schedule information and resource state information such as inventory or status data.

The term “schedule information” refers to data representing temporal allocation of activities or responsibilities, including dates, times, assigned persons, and related metadata for shifts, meetings, or events.

The term “inventory information” refers to data representing quantities, thresholds, and identifiers of items, goods, or resources, including stock levels, reorder levels, and product identifiers.

The term “real-time database” refers to a data store or data management service that allows retrieval or update of data with a latency sufficiently low that the retrieved data can be regarded as reflecting a current operational state at the time of processing by the system.

The term “real-time data store” refers to any database or data management system that supports near-instantaneous access to up-to-date records for use in processing user requests as described in the claims.

The term “attribute information” refers to data describing characteristics of a user, including but not limited to role, department, permission level, experience, or preference data, which can be used to control the behavior of the system.

The term “past interaction history” refers to recorded data representing previous exchanges, commands, or operations between the user and the system, including prior natural language instructions, prompts, and generation results.

The term “operation condition of the generative AI model” refers to any parameter, setting, or control input that influences how the generative AI model generates a generation result, including but not limited to temperature, context specification, or output format constraints.

The term “information presentable to the user” refers to data, including text, lists, or structured objects, that has been formatted or organized so that it can be displayed, rendered, or otherwise output by the terminal in a manner understandable by the user.

The term “manual editing or addition” refers to modification, correction, or supplementation of data by the user via an input interface of the terminal, such as a keyboard, touch screen, pointing device, or voice input.

The term “data in a format allowing manual editing or addition” refers to data that is provided in a representation, such as editable text fields or editable structured records, that can be directly altered or supplemented by the user at the terminal.

The server implements the invention by executing a program on one or more processors and by cooperating with one or more terminals operated by users. The server resides, for example, on a rack-mounted computer or virtual machine in a data center, and the server includes at least one central processing unit, a main memory, a non-volatile storage device, and a network interface. The terminal is, for example, a smartphone, a tablet computer, or a notebook computer equipped with a display, a microphone, a speaker, and a wireless communication module.

The server stores, in a storage device, configuration data and parameters defining an individual generative AI model for each user. The server uses a transformer-type neural network as the generative AI model. The generative AI model includes an embedding layer, multiple self-attention layers, feedforward layers, layer normalization components, and an output projection layer. The server stores the model parameters, such as attention weights, feedforward weights, and bias terms, in a non-volatile memory, and the server loads these parameters into a main memory when the generative AI model is executed. The server maintains, for each user, at least one of: a set of prompt templates, decoding parameters (for example, temperature, top-k, top-p), output formatting constraints, and user-specific context embeddings. By storing user-specific configurations, the server realizes the “individual generative AI model” for each user without requiring a separate physical network for every user.

The terminal executes an application program that captures user input and displays system output. The terminal uses an operating system-supplied audio interface to acquire a voice instruction spoken by the user. The terminal converts an analog audio signal to digital data using an analog-to-digital converter, and the terminal temporarily stores the digital audio data in a buffer in a main memory. The terminal then either transmits the raw or compressed audio data to an external speech-to-text service or executes an on-device speech recognition model. In either case, the terminal obtains text data representing the user's natural language instruction. The text data corresponds to, for example, sentences such as:

“Check today's shift schedule and list the items that are low in stock.”

“Create a meeting invitation for tomorrow at 3 p.m. and prepare a short agenda.”

“Summarize the current inventory status and highlight categories that may run out within three days.”

The terminal transmits the text data, together with user identification information and optional device metadata, to the server over a packet network using a transport protocol such as TCP/IP and an application protocol such as HTTPS.

The server receives the text data and stores it as a string in a memory region. The server then transforms the text data into a prompt sentence for input to the generative AI model. The server generates the prompt sentence by concatenating or otherwise combining (i) the user's instruction text, (ii) a system instruction specifying the expected role of the generative AI model, and (iii) one or more control tokens or markers indicating that downstream components should output structured information. The server uses a deterministic algorithm to generate the prompt sentence so that the prompt follows a consistent structure that can be parsed automatically.

For example, the server may generate a prompt sentence such as:

“You are a task-planning assistant for a workplace system. Interpret the following user instruction, and output a JSON-like plan with fields: task_type, required_data_types, and filters. User instruction: ‘Check today's shift schedule and list the items that are low in stock.’”

In another example, the server may generate a prompt sentence such as:

“You are an assistant that plans database queries for schedule and inventory data. From the user instruction below, determine the relevant data sources and constraints. Respond with: task_type, schedule_constraints, inventory_constraints. User instruction: ‘Summarize the current inventory status and highlight categories that may run out within three days.’”

The server feeds the prompt sentence into a tokenizer associated with the generative AI model. The tokenizer converts each token of the prompt sentence into an integer index according to a vocabulary table, and the server stores the resulting sequence of indices in a tensor structure. The server supplies this tensor to the input layer of the transformer network and processes the sequence through multiple self-attention layers. Each self-attention layer computes attention scores by matrix multiplication between query, key, and value matrices, applies a softmax function, and derives context-dependent representations for each token. The server performs these operations for all layers, applying non-linear activation functions and normalization at each step, until the network outputs a sequence of hidden vectors at the output layer.

The server applies a final linear projection to the hidden vectors to obtain probability distributions over the vocabulary for each time step. The server then uses a decoding algorithm, such as greedy decoding or beam search with a specified beam width, to generate output tokens from the probability distributions. The server controls the decoding by using a temperature parameter, a maximum token count, and banned token lists stored in the user-specific configuration. By adjusting these parameters, the server restricts the generative AI model to produce outputs that conform to a compact, machine-parseable pattern rather than long, free-form text. This restriction is a non-conventional use of a generative AI model: instead of merely generating natural language replies, the server uses the model as a neural planner that outputs structured task descriptions and database query specifications.

The server parses the generation result to obtain a structured representation of a task execution plan. The task execution plan includes, for example, one or more fields that indicate:
(1) A task type, such as “check_shift_and_inventory,” “generate_meeting_invitation,” or “summarize_inventory_risk.”
(2) Required data types, such as “shift schedule for user_id=X and date=today” or “inventory items with quantity less than threshold.”
(3) Filter conditions and parameters, such as “date=current_date,” “user_role=staff,” “quantity<=reorder_level,” or “predicted_run_out_days<=3.”

The server stores this structured task execution plan as an internal data structure, for example as a record with fixed fields in a main memory. By using the generative AI model to produce a structured plan, the server converts an unstructured natural language instruction into a machine-interpretable specification in a single pass, reducing the need for handcrafted heuristic rules and multiple parsing modules. This integrated planning approach reduces computational complexity and processing time compared to conventional architectures that use separate natural language understanding pipelines.

The server then accesses a real-time data store to obtain work-related data needed to execute the task execution plan. The server connects to a schedule data store and a resource state data store through a database client library. The schedule data store stores entries indexed by fields such as staff identifier, date, start time, end time, and location. The resource state data store stores entries indexed by fields such as item identifier, category, current quantity, reorder threshold, and last update time. The server formulates queries using the conditions extracted from the task execution plan. For example, when the task type is “check_shift_and_inventory,” the server generates:
(i) A schedule query such as: “select shift records where staff_id equals the requesting user's identifier and date equals the current date,” and
(ii) An inventory query such as: “select item records where quantity is less than or equal to reorder_level and store_id equals the store associated with the requesting user.”

The server executes these queries using indexed lookups and range scans supported by the database engine. The server arranges the retrieved records in in-memory data structures, such as lists of dictionaries or arrays of structs. The server may pre-sort the records by priority fields, such as earliest shift time or lowest quantity. By encoding a narrow, task-specific query derived from the structured execution plan, the server reduces the volume of data transmitted over the network and minimizes the number of round trips to the database, which in turn improves response latency and reduces communication load.

In one implementation, the server performs further reasoning for presentation by invoking the generative AI model again with a second prompt sentence that includes the retrieved work-related data. The server serializes the work-related data into a compact textual representation and embeds this text in a prompt sentence such as:

“You are a summarization assistant. Given the following shift records and low-stock items, create a concise summary for the user. Emphasize the user's own shift time and the items that require urgent attention. Shift records: [. . . ]. Low-stock items: [. . . ].”

The server then tokenizes this second prompt sentence and executes the transformer network as before. Because the work-related data is already filtered and compacted, this second generation process focuses on formatting and emphasis rather than on large-scale reasoning, which improves computational efficiency and reduces energy consumption.

Alternatively, the server can use a single generative AI pass that already generates both a structured plan and a user-facing summary, storing them as separate segments in the generation result. In yet another embodiment, the server uses a smaller transformer network for summarization than for planning, so that heavy reasoning is centralized in one model instance and lightweight post-processing is delegated to a more efficient network. This modular architecture allows the server to scale across many users by assigning specialized model instances to different stages of processing.

The server combines the summarized text and the structured work-related data into a response message. The server generates, for example, a message such as:

“Your shift today is from 10:00 to 19:00 at Store A. The following items are low in stock and need replenishment: Item X (5 units), Item Y (3 units), Item Z (2 units).”

The server further includes structured fields in the response, such as item identifiers and precise quantities, so that the terminal can display sortable tables, generate alerts, or trigger subsequent workflows. The server transmits the response message to the terminal over a secure transport.

The terminal receives the response message and stores it in a buffer. The terminal extracts the text summary and the structured fields and renders the information on a graphical user interface. The terminal may use list widgets, icons indicating urgency, and color coding to emphasize low-stock items or upcoming shifts. The terminal may also use a text-to-speech engine to read aloud the summary to the user. Because the response includes structured data, the terminal can also allow the user to edit individual fields, such as changing a reorder quantity or correcting a schedule note, and send the edited data back to the server as an update request. The server receives the edited data, validates it, and writes it back into the real-time data store as an updated record.

The server also maintains user-specific attribute information and past interaction history in the storage device. The server includes, for each user, data such as role, department, seniority, typical shift patterns, and previously issued instructions. The server uses this information to adapt the prompt sentence and the model decoding parameters. For example, when the user is identified as a manager role, the server adjusts the prompt sentence to request more aggregated inventory statistics and broader time ranges. When the user frequently rejects certain types of model outputs, the server updates a preference vector that influences the weighting of different output patterns during decoding. The server can implement this preference adaptation by modifying the bias terms of an output layer or by applying a re-ranking algorithm to candidate outputs generated by beam search. This adaptation improves output relevance and reduces the need for the user to manually correct the results, which in turn reduces interaction time and network traffic.

The server improves computer technology by introducing a specific internal data flow and algorithmic structure that are not present in conventional systems. The server uses a neural network not simply to generate human-readable text but to produce constrained, machine-interpretable task plans and query specifications. By constraining the generative AI model with structured prompt sentences and decoding parameters, the server reduces the space of possible outputs and ensures that the outputs can be automatically parsed without expensive secondary natural language understanding modules. This reduces the number of processing stages, decreases memory usage, and lowers processing latency.

Moreover, the server implements a non-conventional feedback mechanism between the generative AI model and the real-time database. The server does not merely retrieve data and then display it; rather, the server uses the generative AI model to compute which specific data should be retrieved and how it should be organized, based on learned patterns from prior training data. Then, after retrieving the exact data segments, the server optionally uses a second model pass to optimize the ordering, grouping, and highlighting of information for the user. This multi-stage neural-database cooperation yields a technical effect of improved bandwidth utilization and query efficiency because the database operations are guided by a learned planner rather than by static query templates.

The server further implements specific training and refinement procedures for the generative AI model to support this behavior. In one embodiment, the server operator trains the transformer model using supervised learning on pairs of (natural language instruction, structured plan) examples. The server computes a cross-entropy loss between the predicted tokens and the ground truth tokens of the plan representation. The server propagates gradients backward through the network using backpropagation and updates the model weights using an optimizer such as Adam. The training data includes diverse workplace instructions and corresponding database query specifications, so that the model learns to map linguistic patterns to data access patterns. In another embodiment, the server applies fine-tuning with reinforcement learning where the reward function measures the success rate of executed queries and the compactness of retrieved datasets. This training procedure encourages the model to generate plans that minimize unnecessary data retrieval and reduce wasted computation, directly improving system-level efficiency.

The server can be implemented in several alternative embodiments. In a first embodiment, the server uses a single large transformer network shared among all users, and stores user-specific configurations in a separate table. In a second embodiment, the server partitions the model into sub-models dedicated to different domains (for example, scheduling, inventory management, communication drafting) and selects the appropriate sub-model based on the initial interpretation of the prompt sentence. In a third embodiment, the server deploys a cascade of models, where a lightweight classifier identifies the task type, and a more powerful generative AI model produces the detailed plan and summary. In each case, the central concept remains that the server generates structured prompt sentences, obtains structured generation results, and uses those results to drive fine-grained, real-time data operations.

The terminal may also take various forms. In one embodiment, the terminal is a handheld device carried by a worker in a physical facility. In another embodiment, the terminal is a fixed kiosk installed in a control room. In a further embodiment, the terminal is a wearable device with limited display capabilities and primarily relies on voice output. In all these cases, the terminal serves to transmit natural language instructions to the server and to present structured, editable outputs to the user.

The user operates the system by issuing natural language instructions instead of manually navigating multiple screens or forms. However, the invention does not merely automate human mental steps; the invention modifies the internal operation of the server, the database, and the neural network so that the computing system achieves concrete technical improvements: faster end-to-end response, reduced amount of data transmitted and processed, improved accuracy of data selection, and decreased need for repeated user corrections. These improvements arise from the specific combination of: (i) individualized generative AI model configurations, (ii) prompt sentence generation and constraint mechanisms, (iii) structured task execution plans that drive database operations, and (iv) real-time, user-editable presentation of results at the terminal.

Through these configurations, the server, the terminal, and the user cooperate in a way that allows the invention to be implemented in practice by existing computing hardware and software platforms, while at the same time providing a technical architecture that can be extended to various domains where natural language instructions must be converted into efficient, precise, and reliable computer operations.

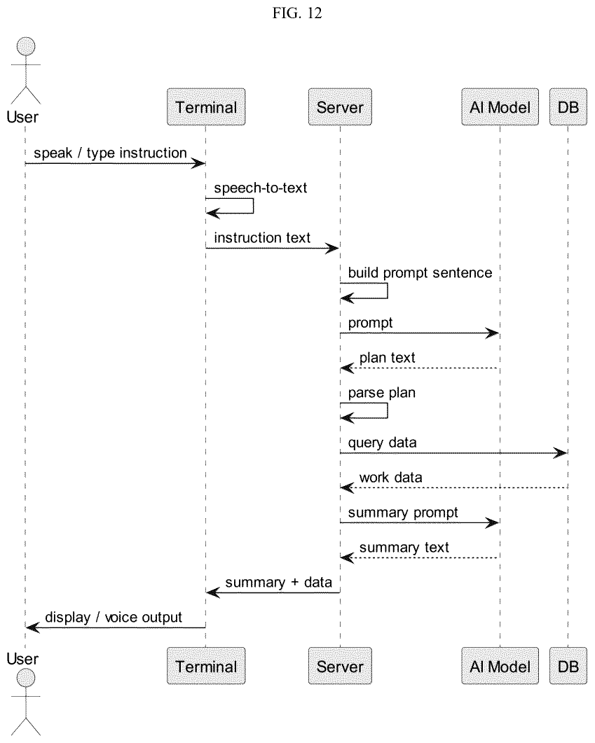

The following describes the processing flow using FIG. 12.
Step 1:

The user provides a natural language instruction.

The user speaks a request, such as “Check today's shift schedule and list the items that are low in stock,” into a microphone of the terminal or types a similar instruction into a text input field. The input of this step is an analog voice signal or a textual string representing the user's instruction. The output of this step is a digital representation of the instruction at the terminal, either as raw audio data or as an initial text string.
Step 2:

The terminal converts the voice instruction into text data.

The terminal receives the analog audio signal from the microphone and samples it using an analog-to-digital converter to generate digital audio frames (for example, 16-bit PCM at a predetermined sampling rate). The terminal optionally compresses or encodes the audio and sends it to a speech recognition component, or executes an on-device speech recognition algorithm, to obtain a transcription. The input of this step is the captured audio data, and the terminal performs feature extraction and pattern matching to map acoustic features to characters or words. The output of this step is text data representing the user's natural language instruction.
Step 3:

The terminal transmits the text data and user information to the server.

The terminal packages the transcribed text together with metadata such as a user identifier, device identifier, and timestamp into a structured message. The terminal uses a communication stack, for example an HTTPS request over TCP/IP, to send this message to the server. The input of this step is the text data and associated metadata held in the terminal's memory. The terminal performs data serialization into a network message format, and the output is a network packet stream delivered to the server.
Step 4:

The server receives and stores the instruction data.

The server accepts the incoming request through a network interface and passes it to a server application running on a processor. The server parses the received message to extract the user identifier, text data, and metadata, and stores these values in main memory or a temporary buffer. The input of this step is the serialized network message, and the server performs deserialization and syntax parsing to obtain internal data structures. The output of this step is an internal representation of the instruction, including a string for the instruction text and fields for the user and context information.
Step 5:

The server generates a prompt sentence for the generative AI model.

The server reads the instruction text and user information and constructs a prompt sentence that includes system guidance, task description, and output constraints. The input of this step is the internal representation of the instruction and user context. The server performs string concatenation, template substitution, and insertion of control tokens to form a structured prompt. For example, the server may generate a prompt sentence such as: “You are a task-planning assistant for a workplace system. Interpret the following user instruction, and output a plan with fields: task_type, required_data_types, and filters. User instruction: ‘Check today's shift schedule and list the items that are low in stock.’” The output of this step is a prompt sentence string ready for tokenization.
Step 6:

The server tokenizes the prompt sentence and prepares input tensors for the generative AI model.

The server supplies the prompt sentence to a tokenizer associated with the generative AI model. The input of this step is the prompt sentence string. The server looks up each sub-word or token in a vocabulary table and converts the string into an array of integer token IDs, and then reshapes this array into a tensor with dimensions suitable for the transformer network. The server may pad or truncate the sequence to a fixed length. The output of this step is an input tensor stored in memory, representing the prompt in a numerical form.
Step 7:

The server executes the generative AI model to generate a structured plan.

The server feeds the input tensor into a transformer-based generative AI model loaded in memory. The input of this step is the token ID tensor. The server performs a sequence of matrix multiplications and non-linear operations through embedding layers, multiple self-attention layers, and feedforward layers to compute hidden state vectors. The server applies an output projection to obtain probability distributions over the vocabulary for each output position, and then applies a decoding algorithm, such as greedy decoding or beam search, governed by user-specific parameters like temperature and maximum length. The output of this step is a sequence of output tokens that form a generation result, which the server decodes into a text string representing a structured task execution plan and, optionally, a preliminary response draft.
Step 8:

The server parses the generation result into a task execution plan.

The server reads the text generated by the generative AI model and converts it into an internal structured representation. The input of this step is the generation result string. The server performs parsing, which may include splitting the string at delimiters, matching field names, and converting numeric text into numerical values. As a result, the server produces a task execution plan object that includes fields such as task_type, required_data_types, schedule_constraints, and inventory_filters. The output of this step is a machine-interpretable data structure stored in memory.
Step 9:

The server formulates database queries based on the task execution plan.

The server examines the task execution plan and selects relevant data sources, such as a schedule data store and an inventory data store. The input of this step is the structured task execution plan. The server converts logical conditions contained in the plan into query expressions, for example by mapping “current date” to a concrete date value and mapping “quantity less than or equal to reorder level” to a comparison expression on two fields. The output of this step is a set of query commands or query objects to be executed against the real-time data stores.
Step 10:

The server retrieves work-related data from real-time data stores.

The server transmits the formulated queries to one or more real-time databases via a database client interface. The input of this step is the set of query objects. The server performs indexed lookups, range scans, or filter operations provided by the database engine and receives structured records that satisfy the query conditions. The server may further filter or sort the records in memory according to the constraints in the task execution plan. The output of this step is work-related data, such as a list of schedule entries and a list of inventory items with low stock, represented as structured records.
Step 11:

The server organizes the retrieved data according to the instruction.

The server takes the work-related data and the task execution plan and arranges the data into a format suitable for presentation or further processing. The input of this step is the raw set of schedule and inventory records and the plan object. The server performs data transformations such as grouping by date, sorting by urgency, aggregating quantities, and selecting only the fields that are relevant to the user. The server may, for example, group inventory items by category and sort them in ascending order of quantity. The output of this step is an organized dataset aligned with the user's instruction.
Step 12:

The server optionally generates a natural language summary using the generative AI model.

The server constructs a second prompt sentence that includes the organized dataset and a summarization instruction. The input of this step is the organized work-related data and the original or derived instruction context. The server converts the data into a compact textual representation and embeds it in a prompt such as: “Given the following shift records and low-stock items, create a concise summary for the user.” The server tokenizes this prompt, runs the generative AI model again with summarization-specific decoding parameters, and obtains a text summary. The output of this step is a natural language summary string describing the shift schedule and low-stock items.
Step 13:

The server composes a response message for the terminal.

The server combines the organized dataset and the optional summary into a response structure. The input of this step is the organized data and the summary text. The server creates fields for summary_text, shift_info, low_stock_items, and other metadata, and then serializes this structure into a format suitable for transmission, such as a JSON message. The server may also include flags indicating success or failure and processing timestamps. The output of this step is a serialized response message stored in a transmission buffer.
Step 14:

The server transmits the response message to the terminal.

The server sends the serialized response message over the network using a communication protocol such as HTTPS. The input of this step is the response message in the transmission buffer. The server performs encryption and packetization as required by the network stack. The output of this step is a stream of network packets that reaches the terminal.
Step 15:

The terminal receives and parses the response message.

The terminal accepts the incoming packets through its network interface and reconstructs the response message. The input of this step is the network packet stream. The terminal performs decryption, checks message integrity, and parses the serialized format to extract fields such as summary_text and structured lists of items. The output of this step is an internal data structure at the terminal containing the information to be presented to the user.
Step 16:

The terminal displays and optionally vocalizes the information to the user.

The terminal reads the internal data structure and renders the summary and details on its display. The input of this step is the parsed response data. The terminal constructs user interface elements such as lists, tables, and labels, and fills them with values like shift times and item quantities. The terminal may also pass the summary_text to a text-to-speech engine, which converts the text into audio signals for playback through a speaker. The output of this step is a visual and/or auditory presentation of the requested information to the user.
Step 17:

The user reviews the information and optionally performs edits or issues a follow-up instruction.

The user observes the displayed schedule and low-stock list and may adjust certain fields, such as changing a quantity or annotating an item, using input controls on the terminal. The input of this step is the information presented by the terminal. The user performs manual operations that modify or confirm the data, and the terminal captures these edits as new input data. The output of this step is updated data or a new natural language instruction, which the terminal can send back to the server, thereby initiating another cycle of processing.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional communication support systems that utilize generative AI models, the computer merely converts an input text into an output draft without deeply integrating task-oriented process control, user-specific auxiliary work execution, or adaptive feedback of execution results into the generative pipeline. As a result, the underlying computer system is used as a passive text generator, and the processing architecture remains limited in at least the following respects.

First, conventional systems generally handle a user's message as a single, flat text unit and do not structurally decompose the message into both (i) reply text information and (ii) machine-executable work support operations with explicit execution order. This forces separate, often manual, workflows for communication drafting and auxiliary task execution, leading to redundant parsing, multiple network requests, and context loss between modules, which in turn increases processor load and latency at the system level.

Second, typical systems do not control the input to the generative AI model with explicit emotion state information derived from the user's communication information, nor do they feed back execution results of auxiliary tasks into the model as structured context. Because the model input is not enriched with such structured signals, the system cannot stably generate reply text that both reflects the actual operational state of related tasks and is tuned to increase a user's sense of security and trust. This leads to sub-optimal use of computational resources: the model must repeatedly infer missing context, and the server cannot reliably converge toward behavior that reduces correction cycles and network interactions.

Third, conventional architectures do not learn or reuse the relationship between natural-language prompt sentences and the corresponding structured task sets and execution orders. Each new prompt is processed as an independent request, so the processor performs similar analysis and scheduling logic repetitively. This lack of prompt-to-task mapping and reuse prevents the system from optimizing internal data structures, cache strategies, and scheduling algorithms over time, and results in unnecessary consumption of computation cycles, increased memory access, and elongated end-to-end processing time.

Accordingly, there is a need for a computer-implemented system that integrates generative AI-based natural language understanding with structured task extraction, priority determination, external service orchestration, and adaptive feedback based on emotion state information and execution results. Such a system should improve the way processors, memories, and communication interfaces cooperate, thereby reducing redundant processing, shortening latency for repeated patterns of auxiliary work, and enhancing the overall efficiency and reliability of the computer system itself.

The specific processing by the specific processing unit 290 of the data processing device 12 in Example 2 is realized by the following means.

The present invention provides a server comprising a processor configured to receive communication information from a user, to analyze the communication information to generate a prompt sentence for causing a generative AI model to generate reply text information and work support operations related to the reply text information, to input the prompt sentence into the generative AI model and obtain structured information including contents of the reply text information and contents of the work support operations and an execution order of the work support operations, to determine priorities of a plurality of the work support operations including at least a time-recording process, a condition-checking process, a communication-information-checking process, and a schedule-adjusting process based on the structured information, to automatically execute each of the work support operations according to the determined priorities via a communication interface of an external information processing service, to present the reply text information generated by the generative AI model to a terminal in an editable format, to control input information to the generative AI model by adding emotion state information estimated from the communication information when generating the prompt sentence such that the reply text information includes contents that increase a sense of security and a sense of trust of the user, to use the emotion state information and execution result information of the work support operations as additional input to the generative AI model so as to adaptively update subsequent reply text information and subsequent work support operations, and to automatically determine the contents of the work support operations and the execution order of the work support operations based on a natural-language prompt sentence designated by the user and record a correspondence between the prompt sentence and an output of the generative AI model so that, for a later prompt sentence, contents of similar work support operations and a similar execution order are estimated and proposed. This enables the computer system to internally convert unstructured communication information into reusable structured task data, to orchestrate external services with reduced redundant analysis, to adapt model behavior using explicit emotion and execution-result feedback, and to optimize processor, memory, and network utilization over time, thereby improving the technical performance and efficiency of the underlying information processing infrastructure.

The term “communication information” refers to information expressed in natural language or symbolic form by a user, including message content, inquiries, reports, and other text data that is input to the system for the purpose of generating a reply or triggering associated operations.

The term “prompt sentence” refers to a natural-language or structured text instruction that is generated or designated for input to a generative AI model, the instruction defining at least one of reply text content, work support operations, parameters of the work support operations, and an execution order of the work support operations.

The term “generative AI model” refers to an artificial intelligence system, typically implemented as a parameterized neural network, that receives a prompt sentence as input and generates output data such as text, structured information, or task descriptions based on learned patterns.

The term “reply text information” refers to text data representing a candidate reply to the communication information, the text data being generated by the generative AI model and intended for presentation to a user in editable or non-editable form.

The term “work support operations” refers to computer-implemented auxiliary processes associated with handling communication information or daily work, including but not limited to recording time information, checking condition information, checking communication information, and adjusting schedule information.

The term “structured information” refers to data output from the generative AI model that is arranged according to a predefined schema or format, such as a list or hierarchical structure, and that includes at least the contents of reply text information, the contents of work support operations, and an execution order of the work support operations.

The term “execution order” refers to ordering information that defines a sequence in which a plurality of work support operations are to be executed by the system.

The term “time-recording process” refers to a work support operation in which the system records time-related data, such as start time, end time, or attendance time, in association with an entity such as a user or an account.

The term “condition-checking process” refers to a work support operation in which the system acquires, records, or evaluates status information related to a state of a user or a resource, including physical, mental, operational, or environmental condition.

The term “communication-information-checking process” refers to a work support operation in which the system accesses stored communication data, such as electronic mail information or message information, and performs at least one of retrieval, filtering, classification, or status confirmation of the communication data.

The term “schedule-adjusting process” refers to a work support operation in which the system accesses scheduling information, such as calendar information or event information, and performs at least one of generating, updating, or arranging time slots for events or meetings.

The term “external information processing service” refers to a computational service distinct from the system's own processor and memory, accessible through a communication interface, and configured to provide at least one of time management, condition management, communication management, or schedule management functions.

The term “communication interface” refers to a hardware or software interface, including a network interface or application programming interface, that enables the system to exchange data with an external information processing service.

The term “emotion state information” refers to data representing an estimated emotional state of a user, such as anxiety, satisfaction, trust, or other affective attributes, the estimation being derived from analysis of communication information or related context.

The term “execution result information” refers to data indicating an outcome of executing a work support operation, including success or failure status, timestamps, identifiers, and error information associated with the execution.

The term “terminal” refers to an information processing device, such as a mobile device, a desktop device, or a display device, configured to present reply text information and other information to a user and to send user input to the server.

The term “editable format” refers to a representation of reply text information that allows a user, via a terminal, to modify, correct, or supplement the text information before final transmission or storage.

In one embodiment, a server executes a program on a hardware platform comprising at least one central processing unit (CPU), an optional graphics processing unit (GPU), a main memory, a non-volatile storage device, and a network interface. The server uses an operating system such as a general-purpose server operating system and runs middleware such as a web server, an application server, and a database management system. The server further executes a generative AI model, for example implemented as a transformer-based neural network using a numerical computation library running on the CPU and/or GPU.

The server stores, in a storage device, a set of software modules including a communication information reception module, a prompt generation module, a generative AI interface module, a structured information analysis module, a task management module, an external service orchestration module, an emotion estimation module, a model context management module, and a prompt-to-task mapping module. The server loads these modules into the main memory and executes them as processes or threads under control of the processor.

The terminal operates as a client device that presents user interfaces and transmits and receives data to and from the server via a communication network. The terminal includes a user input unit such as a touch screen, keyboard, or pointing device, and a display unit such as a liquid crystal display or organic light-emitting display. The terminal runs a client application or web browser that displays a user interface for inputting communication information and prompt sentences, and for viewing reply text information and execution results of work support operations.

The user operates the terminal to input communication information in the form of natural-language text. The terminal sends this communication information to the server using a structured message format over a transport protocol such as HTTP over TLS. The server receives the communication information through the communication information reception module and stores it in a database system such as a relational database. The database stores records including fields such as user identifier, original communication text, time stamp, and processing status.

The server analyzes the communication information using the prompt generation module. The prompt generation module includes a natural language parser that performs tokenization, part-of-speech tagging, and syntactic parsing. The module further executes a semantic role labeling algorithm to identify entities, intents, and constraints in the communication text. Based on the parsed information, the server constructs a prompt sentence to be provided to the generative AI model. This prompt sentence includes system-level instructions, the original communication information, and format constraints that require the model to output both reply text information and work support operations in a structured manner.

The server uses a generative AI model implemented as a multi-layer transformer network. In one embodiment, the transformer model includes an embedding layer that maps tokenized text into dense vectors, a plurality of self-attention layers, feed-forward layers, and a final projection layer to a token vocabulary. Each self-attention layer computes attention weights based on scaled dot products between query, key, and value vectors, and aggregates contextual information over the token sequence. The model uses parameters such as number of layers, number of heads in multi-head attention, hidden dimension size, and dropout rates, which are stored in memory and updated during training but fixed during inference in the deployed system.

The server trains the generative AI model in advance using a training dataset that includes pairs of prompt sentences and target outputs consisting of reply text and structured task descriptions. The server uses a cross-entropy loss function between predicted tokens and ground-truth tokens and updates model weights using a stochastic gradient descent-based optimizer such as Adam. The server may further apply data augmentation techniques such as paraphrasing, synonym replacement, and insertion of noise in task descriptions to improve the model's robustness. During training, the server uses mini-batch processing, backpropagation through the transformer layers, and gradient clipping to stabilize learning.

At runtime, the server inputs the constructed prompt sentence into the generative AI interface module. The module encodes the prompt sentence into tokens, passes the tokens through the transformer model, and obtains an output sequence. The server constrains the output format using decoding strategies such as beam search with penalties for violating structural markers, thereby encouraging the model to produce an output that contains, in a predetermined textual pattern, (i) reply text information and (ii) descriptions of work support operations with associated parameters and execution order indices.

The server parses the model output using the structured information analysis module. This module searches for delimiters or tag patterns in the output, and maps textual segments into a structured internal representation, for example a task list data structure. The task list data structure may be implemented as an array of records, each record including fields such as task type identifier, execution order index, parameter set, and priority score. The server converts textual labels such as “clock-in” or “check emails” into internal task type identifiers using a lookup table. The server thereby obtains structured information including contents of the reply text information, the contents of the work support operations, and the execution order of the work support operations.

The server manages the structured task list using the task management module. The module sorts the task records according to the execution order indices and, if necessary, applies tie-breaking rules based on default priority definitions stored in a configuration table. For example, the server may assign higher priority to a time-recording process than to a schedule-adjusting process when both have identical order indices. This priority resolution is carried out using a deterministic algorithm that compares task type identifiers to a priority mapping, thereby enabling consistent and reproducible task ordering.

The server uses the external service orchestration module to execute the work support operations via external information processing services. For a time-recording process, the server constructs a request message containing a user identifier, current time stamp retrieved from a system clock, and contextual information such as device location if available, and sends the message to an attendance management service through a network API. For a condition-checking process, the server sends a request to a status management service or health management service that stores condition information. For a communication-information-checking process, the server connects to a message management service such as a mail server or messaging server using a communication protocol and retrieves unread message metadata. For a schedule-adjusting process, the server accesses a schedule management service such as a calendar service and creates or updates event records based on time constraints extracted from the structured information.

The server logs execution results of each work support operation in the database. For each task record, the server stores status flags such as success, failure, or partial success, along with error codes, external resource identifiers, and updated time stamps. This execution result information is later used as additional input context for further calls to the generative AI model and for system-level optimization.

The server estimates emotion state information from the communication information using the emotion estimation module. This module may use a dedicated classifier neural network, for example a transformer encoder followed by a classification head, trained to label communication information with emotion categories such as “anxious”, “calm”, or “urgent”. The classifier network uses features such as token embeddings, sentence-level pooled representations, and attention-based summaries. During training of the classifier, the server minimizes a classification loss such as categorical cross-entropy. At inference time, the server obtains emotion state information as probability scores over emotion categories and stores these scores as numerical vectors.

The server incorporates the emotion state information into the prompt sentence by embedding explicit descriptors of the estimated emotional state and by adding control tokens that instruct the generative AI model to produce reply text information that increases the user's sense of security and trust. For example, the server may annotate the prompt sentence with phrases such as “The user appears anxious; respond in a reassuring and clear manner.” The server further includes execution result information of past tasks as context, so that the generative AI model can generate reply text that accurately reflects what operations have been completed in external systems.

The server presents the reply text information to the terminal in an editable format. The server prepares a response message containing the reply text information and metadata such as suggested tone and length. The terminal displays this reply text in a text editing control that allows the user to modify the content before final transmission. The terminal may highlight parts of the text that are associated with certain tasks, enabling the user to see the link between communication content and system operations. This editable format allows the user to retain control over final communication while reducing the effort required to draft initial replies.

The user can input prompt sentences directly to specify or override work support operations. For example, the user can input the following prompt sentences through the terminal:

“Please execute the tasks in this order: clock-in, condition check, check new emails, and schedule a meeting with my manager tomorrow at 10 AM.”

“Every morning, first clock me in, then check my condition, then summarize my unread emails, and finally schedule focus time from 9 to 11 if my calendar is free.”

The server interprets these prompt sentences using the same generative AI pipeline. The prompt-to-task mapping module records the association between the natural-language prompt sentences and the resulting structured task lists in a dedicated mapping table. Each entry in this table includes a representation of the prompt sentence (for example, a vector embedding computed by a sentence encoder network), a reference to the corresponding task list, and statistics such as frequency of reuse and average execution time.

When the server receives a later prompt sentence, the server compares an embedding of the new prompt with stored embeddings using a similarity metric such as cosine similarity. If the similarity exceeds a threshold, the server retrieves the corresponding past task list and uses it as a template. The server may then modify parameters such as dates or participants according to changes in the new prompt. By reusing previously computed task structures, the server reduces the amount of transformer inference and structured analysis needed, thereby reducing processor cycles, memory accesses, and communication overhead.

This internal reuse mechanism results in improved processing speed and reduced latency, particularly for recurring workflows. Because the server maintains a mapping from prompt sentences to structured tasks and uses vector similarity search, the server can avoid repeatedly performing full semantic parsing and task extraction for prompts that are semantically close to previously handled ones. This is a non-conventional use of historical prompts as an index into structured task plans and leads to an improvement in the functioning of the computer system as a whole.

In another embodiment, the server maintains separate generative AI models or parameter configurations for different types of communication contexts. For example, the server may use a model fine-tuned for emotionally sensitive communication in one context and a model fine-tuned for routine status updates in another. The server selects which model or configuration to use based on features extracted from the communication information, such as presence of specific keywords or emotion state information. This selection is performed automatically by a model selection module that uses a decision rule or a lightweight classifier. The result is that the server can reduce errors and improve reply quality without increasing inference cost uniformly across all cases, thereby improving computational efficiency.

In yet another embodiment, the server uses a caching mechanism for partial model outputs. The server stores intermediate representations such as attention-based summaries for frequent user-specific instructions. When a new prompt sentence is similar to a cached pattern, the server reuses part of the intermediate representation, reducing the amount of computation in the transformer layers. This improves throughput of the generative AI processing on the server hardware and reduces the load on the GPU.

The server's specific technical configuration, combining emotion estimation, structured task extraction, priority determination, external service orchestration, and prompt-to-task mapping, yields technical effects that go beyond simple automation of human decision making. The server reduces redundant parsing and network calls by tightly coupling the generation of reply text information with the determination and execution of work support operations in a unified data flow. The server improves accuracy because the generative AI model receives enriched, structured context, including emotion state information and precise execution results, which reduces ambiguity and lowers the number of correction cycles. The server improves computational efficiency by learning and reusing the relationship between natural-language prompt sentences and structured tasks, which optimizes the use of processor and memory resources over time.

The terminal, in cooperation with the server, also contributes to improved technical performance. The terminal can locally validate input length, character encoding, and basic syntax before sending communication information, thereby reducing unnecessary network traffic and server processing for malformed inputs. The terminal can also cache recently displayed reply text information and task results to enable fast re-rendering without re-requesting data from the server.

The user benefits from the system not merely because of business-level efficiency, but because the underlying computer system functions in an improved manner: the server minimizes redundant computation, the memory subsystem stores and reuses structured representations effectively, and the communication interface reduces unnecessary calls to external services by aggregating and scheduling requests based on the structured task list. The combination of transformer-based generative modeling, explicit emotion state integration, structured task representation, and reusable prompt-to-task mapping thus provides a concrete technical solution that enhances processing speed, accuracy, and resource utilization in a computer-implemented environment.

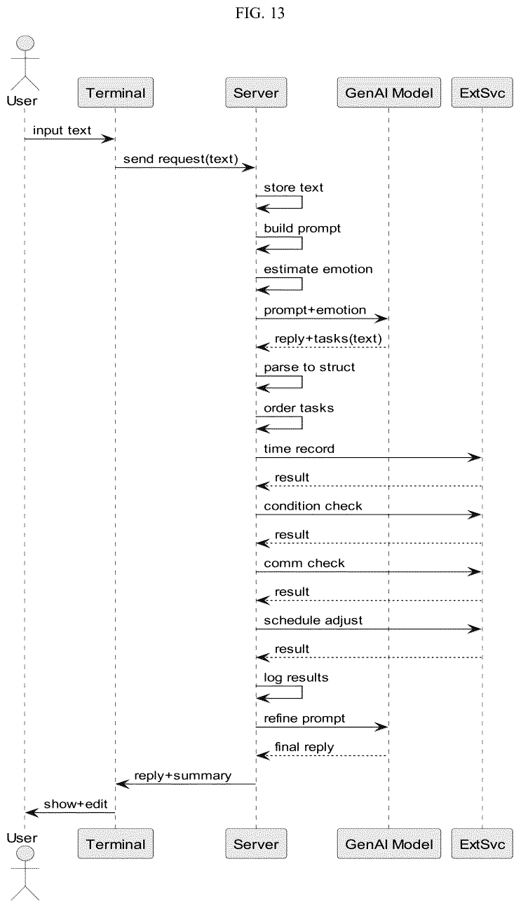

The following describes the processing flow using FIG. 13.
Step 1:

The user operates the terminal to input communication information or a prompt sentence. The user enters natural-language text, such as a message, request, or instruction, into an input field displayed by a client application or web browser on the terminal. As input, the terminal receives raw character data from the user interface device (keyboard, touchscreen). The terminal performs basic validation and encoding (for example, converting to UTF-8 text) and outputs a structured request message containing the text, a user identifier, and a timestamp.
Step 2:

The terminal sends the structured request message to the server. As input, the terminal uses the validated text and associated metadata, and encapsulates them into a network packet using a protocol such as HTTPS. The terminal performs data processing including JSON serialization and header attachment, and outputs an HTTP request addressed to a predefined server API endpoint.
Step 3:

The server receives the HTTP request and extracts the communication information. As input, the server obtains the serialized request from the network interface. The server uses a web framework to parse headers, authenticate the user, and deserialize the JSON body. The server performs data parsing operations to separate the communication text, the user identifier, and the timestamp, and outputs structured internal objects representing the received communication information.
Step 4:

The server stores the received communication information in persistent storage. As input, the server uses the structured internal objects from Step 3. The server performs data processing by mapping object fields to columns in a relational database table and executing an insert operation. The server outputs a database record identifier and an updated processing status (for example, “RECEIVED”) stored alongside the communication information.
Step 5:

The server analyzes the communication information to generate a prompt sentence for a generative AI model. As input, the server uses the stored communication text and associated user context. The server executes natural language processing routines such as tokenization, part-of-speech tagging, and syntactic parsing to identify entities, intents, and constraints. Based on these analysis results, the server concatenates system instructions, emotion-related hints, format guidelines, and the original communication text into a single prompt sentence. The server outputs a constructed prompt sentence that encodes both reply requirements and work support operation requirements.
Step 6:

The server estimates emotion state information from the communication information. As input, the server uses the same communication text and possibly historical interaction records. The server applies an emotion classifier model, such as a transformer-based encoder followed by a softmax layer, to compute probability scores over predefined emotion categories. This involves converting text to tokens, embedding tokens into vectors, propagating them through attention layers, and calculating class probabilities. The server outputs an emotion state vector and a selected dominant emotion label.
Step 7:

The server augments the prompt sentence with emotion state information and execution context. As input, the server uses the base prompt sentence from Step 5 and the emotion state vector from Step 6, along with previously stored execution result information if available. The server performs data processing by inserting descriptive phrases and control tokens into the prompt, indicating the estimated emotional state and instructing the model to respond in a particular tone while reflecting past task results. The server outputs an enriched prompt sentence for the generative AI model.
Step 8:

The server inputs the enriched prompt sentence to the generative AI model and performs inference. As input, the server provides the prompt sentence to a transformer-based generative model via a model interface module. The server tokenizes the prompt, converts tokens to embeddings, and runs them through multiple self-attention and feed-forward layers on the CPU and/or GPU. During this computation, the server calculates attention weights, updates hidden states, and generates output token probabilities step by step. The server applies a decoding algorithm, such as beam search with constraints, to select a sequence of output tokens. The server outputs generated text that includes both reply text information and descriptive content for work support operations with execution order information.
Step 9:

The server parses the generative AI model output into structured information. As input, the server uses the generated output text from Step 8. The server searches for predefined delimiters, tags, or pattern markers that separate the reply text from task descriptions. The server performs string processing operations and applies regular expressions or a simple parser to segment the text. The server converts textual task labels and parameters into a structured task list data structure, such as an array of records, and isolates the reply text as a separate field. The server outputs structured information including a reply text field and a list of task records each containing task type, parameters, and execution order index.
Step 10:

The server determines priorities and execution order for the work support operations. As input, the server uses the task list produced in Step 9. The server performs data processing by sorting the task records according to the execution order indices and applying priority rules. For example, the server compares task type identifiers against a priority mapping table to resolve conflicts when multiple tasks share the same index. The server outputs an ordered task sequence where each record has a finalized position and a computed priority score.
Step 11:

The server registers the tasks in a task management subsystem. As input, the server uses the ordered task sequence and user context. The server inserts each task into a task table in a database or into a job queue, transforming task records into persistence-ready formats and assigning unique task identifiers. The server performs data operations to link tasks to the original communication record and user identifier. The server outputs task entries in the task management subsystem, each initialized with a status such as “PENDING”.
Step 12:

The server executes a time-recording process when such a task is present. As input, the server uses the corresponding task record (including user ID and parameters such as “clock-in” or “clock-out”) and the current system time. The server performs data processing by constructing an API request payload containing the user identifier, a timestamp, and optional location information obtained from previous metadata. The server sends this payload via a communication interface to an external attendance management service and receives a response containing confirmation or error codes. The server outputs an updated task status (for example, “COMPLETED” or “FAILED”) and an external record identifier if the operation succeeded.
Step 13:

The server executes a condition-checking process when such a task is present. As input, the server uses the corresponding task record and any condition-related parameters extracted by the generative AI model (for example, type of condition or time frame). The server constructs a request to a condition or health management service, which may include user identifiers and queries for recent condition entries. The server processes the response by extracting condition values and summaries, and may calculate derived indicators such as trend flags. The server outputs an updated task status and updated condition data stored in association with the user.
Step 14:

The server executes a communication-information-checking process when such a task is present. As input, the server uses the task record that specifies communication channels (for example, email or messaging) and criteria (for example, unread messages). The server connects to a communication management service using appropriate protocols, authenticates using stored tokens or credentials, and issues commands to retrieve message metadata. The server performs data operations by filtering and sorting messages according to time, sender, or importance. The server outputs an updated task status and a structured list of relevant message summaries stored in the database.
Step 15:

The server executes a schedule-adjusting process when such a task is present. As input, the server uses the task record that specifies schedule parameters such as target date, time window, participants, and meeting purpose. The server sends queries to a schedule management service to retrieve free/busy information and calculates candidate time slots by intersecting available intervals. The server then constructs and sends a create-event or update-event request. The server records any event identifiers returned from the schedule service and outputs an updated task status along with stored schedule information.
Step 16:

The server logs execution results and associates them with the original communication information. As input, the server uses updated task statuses and external resource identifiers from Steps 12 to 15, as well as the original communication record ID. The server performs database update operations to write execution result information into corresponding records, including success or failure flags, timestamps, and error messages if any. The server outputs a consolidated execution log that can be retrieved for future context and model input.
Step 17:

The server generates a final reply text for presentation by possibly refining the reply text information based on execution results. As input, the server uses the reply text extracted in Step 9, the emotion state information from Step 6, and the execution log from Step 16. The server may optionally construct an additional prompt sentence that describes which tasks were successfully completed and asks the generative AI model to adjust or annotate the reply text accordingly. The server processes this prompt to obtain a refined reply text. The server outputs finalized reply text information that accurately reflects completed operations and addresses the user's emotional state.
Step 18:

The server sends the finalized reply text and execution summary to the terminal. As input, the server uses the finalized reply text, structured summaries of task execution, and any recommendations for future actions. The server serializes this information into a response message, including identifiers and status codes. The server outputs an HTTP response containing the reply text and related data formatted for display on the terminal.
Step 19:

The terminal receives the response and displays the reply text information in an editable format. As input, the terminal uses the response data from the server. The terminal performs data parsing to extract the reply text, task summaries, and metadata. The terminal updates the user interface by rendering the reply text in an editable text area and showing a list or icons indicating which work support operations were executed and their outcomes. The terminal outputs updated screen content and waits for user interactions such as editing, approval, or additional prompt sentence input.
Step 20:

The user reviews the displayed reply text and task results, and optionally issues additional instructions. As input, the user uses the visual information presented on the terminal to confirm that the time-recording, condition-checking, communication-information-checking, and schedule-adjusting processes were executed correctly. The user may edit the reply text and approve it for sending, or enter a new prompt sentence, such as “If there are more than 10 unread emails, summarize the subjects and send me a short report.” The terminal captures this new input and outputs a new structured request to the server, allowing the overall processing cycle to continue with reused prompt-to-task mappings and optimized internal computations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented communication systems that assist human operators in drafting replies to messages generally treat incoming text as unstructured content and invoke a text generation engine in a uniform, context-agnostic manner. Such systems typically pass the raw or lightly preprocessed message directly to a language model, obtain a single monolithic reply, and display it as static text to the operator. As a result, the systems exhibit several technical deficiencies.

First, the systems lack a structured prompt generation layer that transforms heterogeneous input signals (for example, message content, sender attributes, and situational context) into a machine-optimised prompt sentence for a generative AI model. Without such structured prompt generation, the utilization of the generative model is sub-optimal, leading to unnecessary inference iterations, increased processing time, and unstable output quality from the standpoint of the computer system.

Second, the systems do not integrate an emotion estimation pipeline into the core control flow of prompt generation and output selection. In existing approaches, any sentiment analysis is often applied as a superficial tag and is not tightly coupled with the construction of the prompt sentence or the evaluation of generated candidates. Consequently, the generative model is driven by incomplete state information, and the system cannot consistently generate responses that are tuned to the sender's emotional state. This mismatch leads to additional manual corrections by the operator and inefficient use of computing resources.

Third, many systems return a single reply candidate and do not implement a processor-side evaluation and prioritization mechanism for multiple generated candidates. The lack of internal scoring based on objective indices such as working-time reduction, readability, and emotional suitability forces the human operator to spend more time scanning and editing, and prevents the system from automatically converging toward higher-quality outputs. From a computer-technology perspective, this results in wasted model output, redundant rendering operations, and an overall increase in interaction latency between the processor and the operator terminal.

Accordingly, there is a need for an improved computer-implemented system that (i) programmatically generates structured prompt data, including a prompt sentence, based on natural language analysis and contextual information, (ii) incorporates emotion estimation of the sender into the prompt generation logic, and (iii) evaluates and prioritizes multiple generated reply candidates using predefined evaluation indices, so as to reduce operator workload, stabilize model behavior, and improve the efficiency and effectiveness of the underlying computing resources.

The specific processing by the specific processing unit 290 of the data processing device 12 in Application Example 2 is realized by the following means.

The present invention provides a server comprising a processor configured to receive communication content from a remote terminal via a communication network, analyze the communication content using natural language processing, and, based on an analysis result together with attribute information or situation information associated with a sender, generate prompt data including a prompt sentence that specifies a creation policy and a writing style for a reply draft, the processor further being configured to input the prompt data to a generative AI model disposed internally or externally with respect to the server and to obtain generated text including at least one reply candidate from the generative AI model, to convert the generated text into an editable display format and transmit the converted generated text to an operator terminal, to acquire an editing result from the operator terminal and store the editing result as reply data associated with transmission management information, and to transmit the reply data to the remote terminal via a predetermined communication path, and the processor being further configured, when generating the prompt data, to perform emotion estimation processing on the communication content so as to specify an emotional state of the sender and to control the prompt sentence in accordance with the emotional state, and, when plural reply candidates are included in the generated text, to evaluate the plural reply candidates based on at least one evaluation index relating to working-time reduction, readability, or emotional suitability, assign priorities to the plural reply candidates based on evaluation scores, and control an order or emphasis degree of presentation of the reply candidates on the operator terminal in accordance with the assigned priorities. This enables the computer system to more efficiently orchestrate data flows between message input, prompt sentence construction, generative AI inference, and user interface rendering, thereby reducing overall processing time and operator workload, stabilizing the quality and emotional appropriateness of generated replies, and improving the technical performance of the server in managing and utilizing generative AI model outputs.

The term “communication content” refers to text data or equivalent linguistic information transmitted from a remote party, such as a guardian or other sender, which is received by the server and used as an input for analysis and reply generation.

The term “guardian terminal” refers to an electronic device operated by a remote party, such as a guardian or other message sender, that is capable of transmitting communication content to the server and receiving reply data from the server via a communication network.

The term “teacher terminal” refers to an electronic device operated by an operator, such as a teacher or other human reviewer, that is capable of receiving generated text from the server, presenting the generated text in an editable format, and transmitting editing results back to the server.

The term “remote terminal” refers to a generic electronic device, including but not limited to a guardian terminal or other user terminal, that communicates with the server to send communication content and receive reply data.

The term “operator terminal” refers to a generic electronic device, including but not limited to a teacher terminal or other operator device, that is used by a human operator to review, edit, and approve generated reply candidates provided by the server.

The term “processor” refers to one or more hardware processing units, such as a central processing unit, a graphics processing unit, or a dedicated accelerator, that execute instructions to perform the functions of receiving, analyzing, generating, evaluating, and transmitting data as described in the present invention.

The term “communication network” refers to any wired or wireless data transmission infrastructure, including local networks and wide-area networks, that enables data exchange between the server and one or more terminals.

The term “natural language processing” refers to a class of computer-implemented techniques for analyzing and interpreting human language text, including operations such as tokenization, syntactic parsing, semantic analysis, entity extraction, and sentiment analysis.

The term “attribute information” refers to data describing characteristics of a sender or related entity, such as role, relationship, historical interaction patterns, or demographic information, which is used by the processor as context when generating prompt data.

The term “situation information” refers to contextual data associated with a communication event, including timing, prior message history, system state, or environmental conditions, which is used by the processor to influence analysis and prompt generation.

The term “prompt data” refers to structured data generated by the processor that includes at least one prompt sentence and optionally additional control parameters, and that is supplied as an input to a generative AI model to guide text generation.

The term “prompt sentence” refers to a natural-language instruction or description generated by the processor and included in the prompt data, which defines a creation policy, a writing style, a tone, or other constraints to direct the behavior of the generative AI model.

The term “creation policy” refers to a set of rules or guidelines encoded by the processor, and reflected in the prompt sentence, that specify how the generative AI model should structure, emphasize, or constrain the content of the reply draft.

The term “writing style” refers to stylistic characteristics of a generated reply, such as formality level, politeness, length, and wording preferences, that are indicated in the prompt sentence and used to control the generative AI model.

The term “generative AI model” refers to a machine-implemented model, such as a language model or other generative model, that receives prompt data including a prompt sentence and outputs generated text, including one or more reply candidates.

The term “generated text” refers to text data output by the generative AI model in response to the prompt data, including at least one reply candidate that the server can present to the operator terminal.

The term “reply draft” refers to a preliminary version of response text generated by the generative AI model based on the prompt data, which is intended to be reviewed and optionally edited by a human operator before being sent as final reply data.

The term “reply candidate” refers to an individual alternative reply included in the generated text, which the processor can evaluate, prioritize, and present to the operator as one of multiple possible responses.

The term “editable display format” refers to a data representation and user interface arrangement generated by the processor that allows a user at the operator terminal to view, modify, and confirm generated text.

The term “editing result” refers to modified text and related metadata produced by a user at the operator terminal when editing the generated text, and transmitted back to the server as the basis for final reply data.

The term “reply data” refers to final response information generated on the basis of the editing result and any additional processing by the processor, which is associated with transmission management information and sent to the remote terminal.

The term “transmission management information” refers to control data used by the processor to manage sending of reply data, including identifiers, timestamps, destination addresses, protocol information, and status flags.

The term “predetermined communication path” refers to one or more selected communication routes or protocols, configured in advance, that the processor uses to transmit reply data from the server to a remote terminal.

The term “emotion estimation processing” refers to a computational procedure by which the processor analyzes communication content or related data to infer an emotional state of the sender, such as concern, satisfaction, or anger.

The term “emotional state” refers to a classification or quantitative representation of a sender's affective condition, determined by emotion estimation processing, which is used to control the content and tone of the prompt sentence and generated replies.

The term “expression policy” refers to constraints or preferences regarding linguistic expression, such as degree of empathy, directness, or reassurance, which the processor encodes into the prompt sentence in accordance with the sender's emotional state.

The term “level of explanation detail” refers to a degree of granularity or depth of information included in a reply, as controlled by the processor and specified in the prompt sentence.

The term “proposal content” refers to specific suggestions, actions, or next steps that are included in a reply, which the processor tailors according to the sender's emotional state and incorporates into the prompt sentence.

The term “evaluation index” refers to one or more quantitative or qualitative criteria that the processor uses to compare and score multiple reply candidates, such as expected working-time reduction, readability, and emotional suitability.

The term “working-time reduction” refers to an effect by which the use of a particular reply candidate or workflow is expected to decrease the amount of time required by a human operator to review, edit, and send a reply.

The term “readability” refers to a measure of how easily a recipient can understand a reply candidate, including factors such as sentence length, vocabulary complexity, and structural clarity.

The term “emotional suitability” refers to a degree of alignment between a reply candidate and the inferred emotional state of the sender, including appropriateness of tone, empathy, and level of reassurance.

The term “priority” refers to an order of preference or ranking assigned by the processor to reply candidates based on evaluation indices, which is used to determine how the candidates are presented to the operator.

The term “order of presentation” refers to the sequence in which reply candidates are displayed on the operator terminal, which the processor adjusts in accordance with assigned priorities.

The term “emphasis degree of presentation” refers to a visual or interaction-related weighting, such as highlighting, font size, or prominence, that the processor applies to one or more reply candidates on the operator terminal based on their priorities.

In one embodiment, a server, a terminal, and a user cooperate to implement the claimed system. The server comprises at least one processor, a memory, and a communication interface connected via a bus. The terminal comprises a user interface, a display unit, an input unit, and a communication interface. The user operates the terminal to send communication content and to review and edit generated reply candidates.

The server executes a program stored in the memory. The program includes modules for communication management, natural language processing, emotion estimation, prompt construction, generative AI model interfacing, candidate evaluation, and presentation control. The server runs an operating system such as a general-purpose server operating system and an application stack implemented in a programming language such as a high-level language. The server may additionally employ a database management system for persistent storage of messages, analysis results, and logging information.

The terminal executes a client application that communicates with the server via a communication network. The terminal may be a general-purpose computing device, such as a personal computer or a smart device, and may run a web browser or a native application. The user uses the terminal to input communication content, to view the generated text in an editable format, and to provide an editing result back to the server.

The server receives communication content transmitted from a remote terminal. The server stores the raw text as a record in a message table in the database. The record may include fields such as a message identifier, a sender identifier, a timestamp, and a body field containing the communication content. The server applies natural language processing to the communication content. The server may use a natural language processing library, such as a syntactic and semantic parsing library, to perform tokenization, sentence segmentation, part-of-speech tagging, dependency parsing, and named entity recognition. The server may also compute vector representations of sentences using an encoder network such as a transformer encoder.

The server derives attribute information and situation information from the stored data. The server may access a user profile table that stores metadata about the sender, such as role, previous communication patterns, or interaction history. The server may access a conversation history table that stores prior messages and replies associated with the current sender and thread. The server may compute statistical features from the history, such as average message length, frequency of questions, and prior sentiment scores. These features are collectively used as context information.

The server performs emotion estimation processing on the communication content. The server may compute emotion features using a sentiment classifier implemented as a neural network. For example, the server may use a recurrent neural network, a convolutional neural network, or a transformer-based classifier trained on labeled emotional text data. The server may process token embeddings, apply multiple attention layers, and output a probability distribution over emotion categories such as “concerned”, “angry”, “satisfied”, or “neutral”. The server selects the emotion category with the highest probability and may also record the probability values as emotion intensity measures. The server thereby specifies an emotional state of the sender.

The server constructs prompt data including a prompt sentence. The server composes the prompt sentence as a natural-language instruction string that encodes a creation policy, a writing style, an expression policy, a level of explanation detail, and proposal content constraints. The server selects these elements in accordance with the analysis result, the attribute information, the situation information, and the emotional state.

For example, when the server determines that the emotional state is “worried” and the topic relates to a child's performance, the server may generate a prompt sentence such as:

“A parent is worried about their child's recent academic performance and exam results. Draft a reply from a teacher that reassures the parent, clearly explains the current situation, and proposes concrete support measures at school. Use a polite and empathetic tone and keep the explanation detailed but concise.”

In another example, when the server determines that the emotional state is “angry” and the context involves a complaint about an event, the server may generate a prompt sentence such as:

“A sender is angry about a recent incident involving their child. Draft a professional reply that acknowledges the concern, apologizes appropriately, explains what actions have been taken, and proposes reasonable next steps. Use a calm and respectful tone and avoid defensive language.”

The server may also generate additional control parameters to accompany the prompt sentence, such as maximum target length, temperature for sampling, or constraints on specific phrases to include or avoid. The server stores the prompt sentence and these parameters together as prompt data in a data structure.

The server interfaces with a generative AI model. The generative AI model may be deployed as an internal inference service or accessed through an external model service via an application programming interface. The generative AI model may be a neural network language model that has an encoder-decoder or decoder-only architecture with multiple attention layers, such as a transformer architecture. The generative AI model receives the prompt data, including the prompt sentence, and generates text tokens auto-regressively. The server may set model parameters such as beam width, temperature, top-k value, or top-p value to control generation diversity and coherence.

The server configures the generative AI model to output multiple reply candidates in a single inference session. The server may use a beam search decoding algorithm to maintain several top-scoring token sequences. The server receives multiple reply candidates as text strings. The server stores these candidates in a candidate table associated with the message identifier.

The server processes the generated text to normalize format. The server may remove leading phrases that are not part of the reply, enforce sentence-ending punctuation rules, or apply simple grammatical post-processing. The server then executes a candidate evaluation module. The candidate evaluation module computes evaluation indices for each reply candidate. These indices may include an estimated working-time reduction score, a readability score, and an emotional suitability score.

The server may estimate working-time reduction by measuring candidate length, structural simplicity (number of clauses), and re-use of common templates, as shorter and more structurally regular replies generally require less manual editing. The server may estimate readability using metrics such as average sentence length, type-token ratio, or scores derived from language difficulty indices. The server may estimate emotional suitability by re-applying the emotion classifier to the candidate text and comparing the predicted output to a target emotional tone derived from the sender's emotional state. For instance, when the sender is “worried”, the server may assign higher scores to replies predicted as “reassuring” or “empathetic” and penalize replies predicted as “neutral” or “cold”.

The server combines these indices into an overall priority score for each candidate. The server may use a weighted sum, where weights are stored as configuration parameters, or may use a separate ranking model that has been trained to map features to a priority ranking. The server thereby assigns a priority value or rank to each reply candidate. The server records these priority values in association with each candidate.

The server converts the prioritized candidates into an editable display format. The server generates a data structure that includes the full text of each candidate, its priority, and formatting instructions for the terminal. The server transmits this data via the communication network to the operator terminal. The server may control the order and emphasis of presentation by arranging the highest-priority candidate at the top of a list and applying highlighting or other visual emphasis indications, while lower-priority candidates are displayed less prominently.

The terminal receives the editable display format and renders it on the display unit. The terminal may use a graphical user interface implemented in a browser or native framework. The terminal displays the highest-priority reply candidate in an editable text area and may show other candidates in collapsible sections. The user can edit text directly, combine parts of different candidates, or input new text. The terminal records the user's edits as an editing result.

The terminal sends the editing result back to the server. The editing result includes the final approved reply text and, optionally, annotations indicating which candidate and which segments were adopted. The server stores the editing result as reply data in association with the original message identifier and transmission management information. Transmission management information may include destination address data, protocol information, sending time, and status flags.

The server transmits the reply data to the remote terminal. The server uses a predetermined communication path such as an electronic mail path, a messaging system path, or a school communication platform path. The server may use a transport protocol stack, such as a mail transfer protocol or a secure web protocol, to deliver the reply data. The server updates the message record with a sent status and logs the transaction.

The described architecture and algorithms provide technical improvements beyond mere automation of human drafting. The server restructures heterogeneous inputs into machine-optimized prompt data, including a prompt sentence that encodes multi-dimensional control signals, thereby improving utilization of the generative AI model and reducing inference rounds. The server's emotion estimation and prompt control mechanism feed back into the generative AI model in a non-conventional way: the system does not simply label emotional content but algorithmically changes the prompt content, writing style, and explanation level depending on the emotion. This structured feedback loop reduces misaligned outputs and thus reduces the need for additional processing and manual correction, which contributes to reduced processing time and more efficient use of processor and network resources.

The server implements a non-conventional multi-candidate evaluation path. Instead of presenting raw outputs to the user, the server internally computes evaluation indices and optimizes candidate selection according to technical criteria. This candidate scoring reduces total user interaction steps and rendering load, which is a specific improvement in the way the computer presents and manages generated content. Because the evaluation module uses measurable scores and a defined ranking algorithm, the system can adapt thresholds and weights to balance computational cost and output quality, achieving improved performance.

The generative AI model itself may be trained using a supervised learning or reinforcement learning scheme. The server or a training system may collect pairs of prompt sentences and desired replies, annotate them with emotional states, and train a transformer-based language model. The model may be trained using a cross-entropy loss function over token predictions. Weights are updated by gradient-based optimization algorithms, such as stochastic gradient descent with momentum or adaptive learning-rate methods. The training data may be augmented by paraphrasing, back-translation, or noise injection to improve robustness. The emotion classifier may be trained on labeled emotional text with a similar training procedure. This explicit description of training, loss computation, and weight update clarifies that the generative AI model and emotion classifier are technical artifacts shaped by specific data and optimization procedures.

The server's internal data structures and control flow also contribute to technical effects. The server stores parsed features, emotion scores, prompt data, and candidate evaluations in normalized tables and indexed structures, allowing fast retrieval and reduced data redundancy. By reusing parsed and emotion features across multiple candidate generations, the server avoids recomputing heavy analyses, thus reducing processing load. The server may also schedule calls to the generative AI model in batches, aggregating multiple prompt data entries and issuing them in a single inference batch. This reduces communication overhead between the server and the model host and improves throughput and latency.

The system can be implemented in alternative embodiments. In one variation, the generative AI model resides on the same physical machine as the server, and the server uses a direct inter-process interface to invoke model inference. In another variation, the generative AI model is hosted on a separate computing node or acceleration device, and the server communicates with it over a local network using a remote procedure call protocol. In one embodiment, the emotion estimation is performed locally on the server, while in another embodiment, the server calls an external emotion analysis service via a network interface.

The terminal can also vary. In one embodiment, the terminal is a desktop computer running a web browser, and the editable display format is implemented as a hypertext representation. In another embodiment, the terminal is a smart device running a dedicated application that uses a specific graphical component library. The core components remain the same: the terminal receives the editable display format, renders the prioritized candidates, accepts user edits, and returns the editing result.

The system is suitable for various technical environments, including educational communication platforms, healthcare communication systems, and customer support portals, where structured prompt generation, emotion-aware control, and multi-candidate evaluation are employed to improve the operation of the computing system. In all these embodiments, the server, by combining natural language analysis, emotion estimation, prompt sentence construction, controlled use of a generative AI model, and structured candidate ranking, provides improved computational efficiency, more consistent output quality, and reduced communication and processing load, thereby improving computer technology itself rather than merely automating a manual workflow.

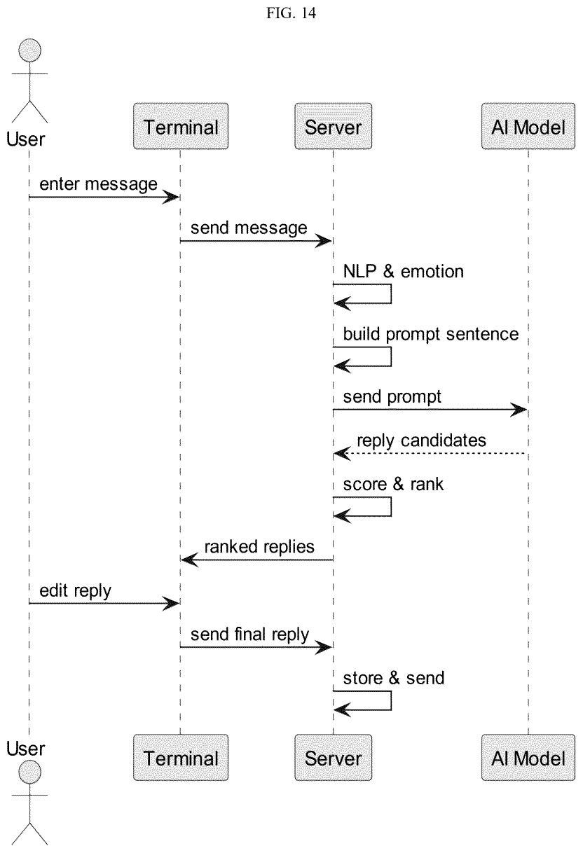

The following describes the processing flow using FIG. 14.
Step 1:

The user operates the terminal to input communication content.

The terminal displays an input form or text area and accepts a message typed or pasted by the user, together with optional metadata such as subject, student identifier, or category.

Input: raw text entered by the user and metadata (e.g., sender ID, timestamp).

Output: a structured request object containing the communication content and metadata.

The terminal encapsulates the text and metadata into a structured data object and transmits the request object to the server via a communication network using a predetermined protocol.
Step 2:

The server receives the request object from the terminal and records the communication content.

The server parses the received data, validates required fields, and assigns a message identifier.

Input: structured request object containing communication content and metadata.

Output: a stored message record and an internal message identifier.

The server writes the communication content, metadata, and the generated message identifier into a message table in a storage device, thereby preparing the data for subsequent analysis.
Step 3:

The server performs natural language processing on the stored communication content.

The server retrieves the message record from storage and applies a natural language processing module to segment sentences, tokenize words, tag parts of speech, and detect named entities.

Input: communication content text and associated metadata.

Output: an analysis result including token lists, sentence boundaries, syntactic structures, and extracted entities.

The server performs data processing by converting the raw text into a structured linguistic representation, which reduces ambiguity and allows later modules to refer to specific tokens, phrases, and entities as discrete data elements.
Step 4:

The server acquires attribute information and situation information associated with the sender.

The server queries profile data and conversation history tables using the sender identifier and the message identifier.

Input: sender identifier and message identifier.

Output: attribute information (e.g., role, relationship, historical interaction statistics) and situation information (e.g., conversation history, prior sentiment, time context).

The server performs data aggregation by combining retrieved records, calculating statistics such as average message length or prior sentiment distribution, and storing the aggregated context information in an internal context object.
Step 5:

The server performs emotion estimation processing on the communication content.

The server encodes the tokens or sentence vectors into numerical features and feeds them into an emotion classification model, which may be a neural network with multiple layers.

Input: linguistic features derived from the communication content and, optionally, features derived from attribute information and situation information.

Output: an emotional state label (e.g., worried, angry, neutral) and associated probability scores.

The server performs data computation by applying matrix multiplications, non-linear activation functions, and softmax operations over the feature vectors, thereby deriving an emotion probability distribution from which the server selects the most probable emotional state.
Step 6:

The server generates a prompt sentence and constructs prompt data.

The server examines the analysis result, the attribute information, the situation information, and the emotional state, and composes a natural-language instruction string that encodes a creation policy, a writing style, a level of explanation detail, and proposal content.

Input: analysis result, attribute information, situation information, emotional state label and scores.

Output: prompt data including at least one prompt sentence and optional generation control parameters.

The server performs data synthesis by mapping internal features to textual constraints and concatenating them into a coherent prompt sentence, for example:

“A parent is worried about their child's recent academic performance and exam results. Draft a reply from a teacher that reassures the parent, clearly explains the current situation, and proposes concrete support measures at school. Use a polite and empathetic tone and keep the explanation detailed but concise.”

The server then packages this prompt sentence together with control parameters such as maximum length and temperature into a prompt data structure to be supplied to the generative AI model.
Step 7:

The server transmits the prompt data to the generative AI model and initiates text generation.

The server formats the prompt data according to the interface specification of the generative AI model and sends it over an internal or external communication channel.

Input: prompt data including the prompt sentence and generation parameters.

Output: a generation request delivered to the generative AI model.

The server performs protocol conversion and serialization, transforming the prompt data into a sequence of tokens or a standardized request format so that the generative AI model can correctly interpret and process the input.
Step 8:

The generative AI model generates multiple reply candidates and returns generated text to the server.

(The server orchestrates this processing, even if the generative AI model executes on a separate computing resource.)

The generative AI model receives the tokenized prompt sentence and performs auto-regressive decoding using its learned parameters, maintaining several candidate sequences through mechanisms such as beam search.

Input: tokenized representation of the prompt sentence and generation parameters.

Output: multiple reply candidates as generated text sequences.

The server receives the generated text, which is typically a set of candidate replies, and reassembles the tokens into text strings, thereby obtaining multiple alternative reply drafts for the same communication content.
Step 9:

The server normalizes and stores the generated reply candidates.

The server processes the raw generated text to remove extraneous prefixes, enforce formatting constraints, and ensure completeness of sentences.

Input: multiple raw generated reply candidate texts.

Output: cleaned reply candidate texts stored in a candidate table linked to the original message identifier.

The server performs text post-processing operations such as trimming, punctuation correction, and encoding normalization, then writes each candidate with its index and associated metadata into storage for later evaluation.
Step 10:

The server evaluates each reply candidate using predefined evaluation indices.

The server computes a working-time reduction metric, a readability metric, and an emotional suitability metric for each candidate by analyzing its length, structure, vocabulary complexity, and predicted emotional tone.

Input: cleaned reply candidate texts, evaluation configuration parameters, and target emotional state.

Output: a set of evaluation scores for each reply candidate.

The server performs data computation by applying statistical calculations (e.g., word counts, sentence lengths), readability formulas, and an emotion classifier to the candidates, producing quantitative scores that characterize the expected editing effort, clarity, and emotional alignment of each candidate.
Step 11:

The server assigns priorities to the reply candidates based on the evaluation scores.

The server combines the evaluation scores using a ranking function, such as a weighted sum or a learned ranking model, and determines a priority value for each candidate.

Input: evaluation scores for all reply candidates.

Output: a priority-ordered list of reply candidates with associated priority values.

The server performs ranking operations by sorting the candidates according to their composite scores and storing the sorted order and priority values, thereby identifying which candidate should be presented most prominently to the user.
Step 12:

The server converts the prioritized candidates into an editable display format and sends them to the terminal.

The server generates a structured response that specifies the text of each candidate, its priority ranking, and presentation attributes such as highlighting or expansion state.

Input: priority-ordered list of reply candidates and presentation configuration parameters.

Output: an editable display object transmitted to the terminal.

The server performs data formatting by organizing candidates into a hierarchical structure suitable for the terminal user interface, then transmits this structure over the communication network for rendering.
Step 13:

The terminal receives the editable display object and renders the reply candidates.

The terminal parses the display object and displays the highest-priority candidate in an editable text area, while presenting other candidates in a list or collapsible sections.

Input: editable display object containing reply candidates and presentation attributes.

Output: a graphical user interface showing candidates ready for user interaction.

The terminal performs rendering operations by mapping presentation attributes to specific UI components, such as text fields and buttons, and by activating editing functions that allow the user to modify the candidate text.
Step 14:

The user reviews and edits the presented reply candidate(s) on the terminal.

The user reads the highest-priority reply candidate, optionally opens other candidates, and modifies text by adding, deleting, or rephrasing sentences according to the user's judgment.

Input: displayed reply candidate texts and associated UI controls.

Output: an editing result containing the finalized reply text and, optionally, information about which candidate served as the base.

The terminal records every modification and, when the user confirms completion, consolidates the modified text and metadata into an editing result object to be returned to the server.
Step 15:

The terminal transmits the editing result to the server.

The terminal encapsulates the finalized reply text, the original message identifier, and any relevant candidate selection data into a structured payload.

Input: editing result created by the user on the terminal.

Output: an editing result payload sent to the server via the communication network.

The terminal performs serialization and network transmission so that the server can store and further process the finalized reply.
Step 16:

The server stores the editing result as reply data and associates it with transmission management information.

The server receives the editing result payload, validates its integrity, and writes the finalized reply text into a reply table linked to the original message identifier.

Input: editing result payload containing finalized reply text and references to the original message.

Output: reply data stored in persistent storage with associated transmission management records.

The server performs data association by creating or updating records that include destination addresses, sending protocol, timestamps, and status flags, thereby preparing the reply for controlled transmission.
Step 17:

The server transmits the reply data to the remote terminal via a predetermined communication path.

The server selects an appropriate communication channel, such as an email path or a secure messaging path, based on configuration and the stored transmission management information.

Input: reply data and transmission management information.

Output: a transmitted reply message delivered to the remote terminal and a status update recorded in the server.

The server performs protocol-specific operations, such as constructing message headers, encoding the reply body, initiating a network connection, and handling acknowledgments. The server then updates the status of the message in storage to indicate successful or failed delivery, completing the processing flow for the communication content.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

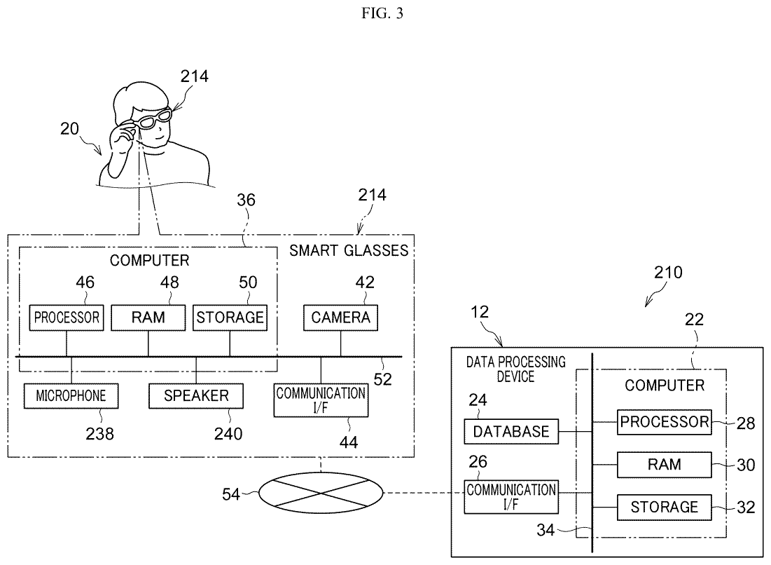

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

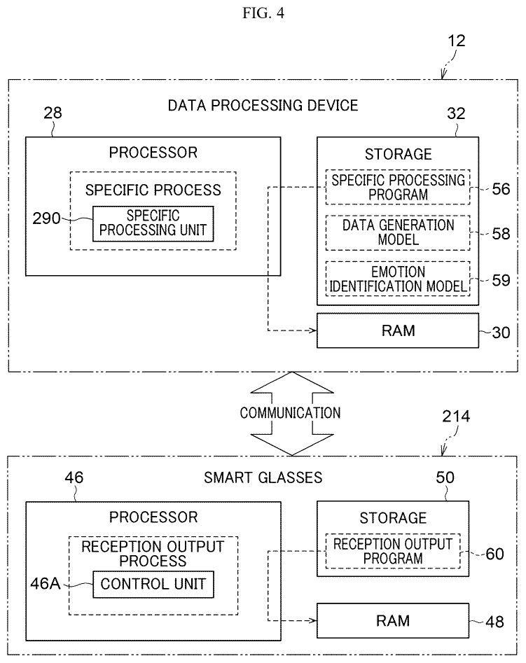

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

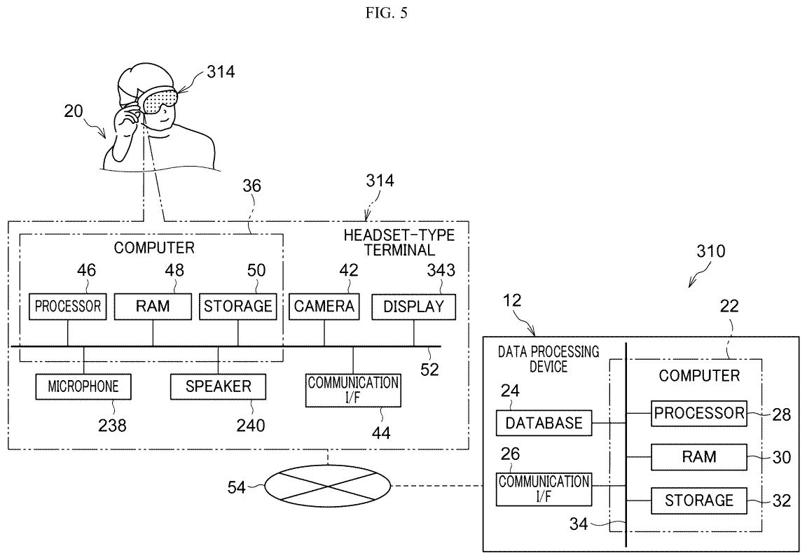

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

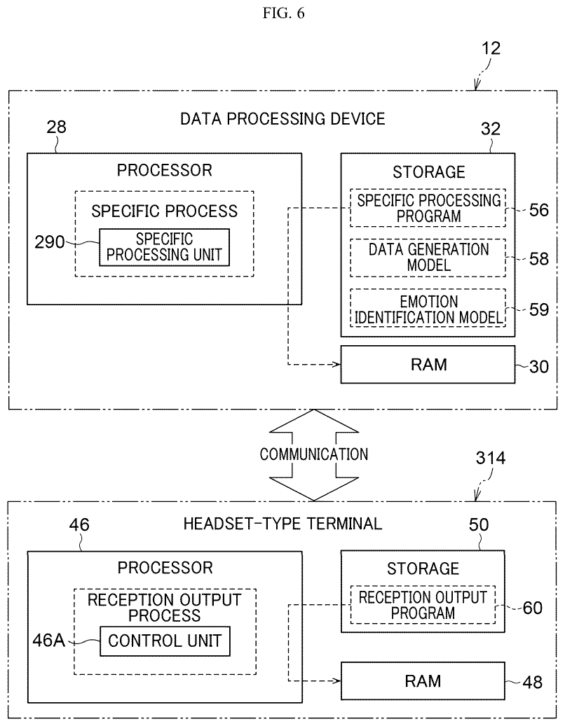

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

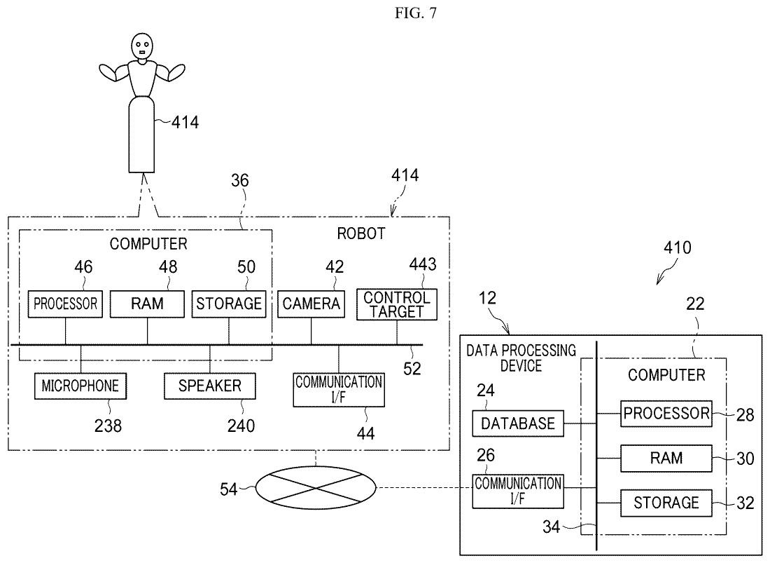

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

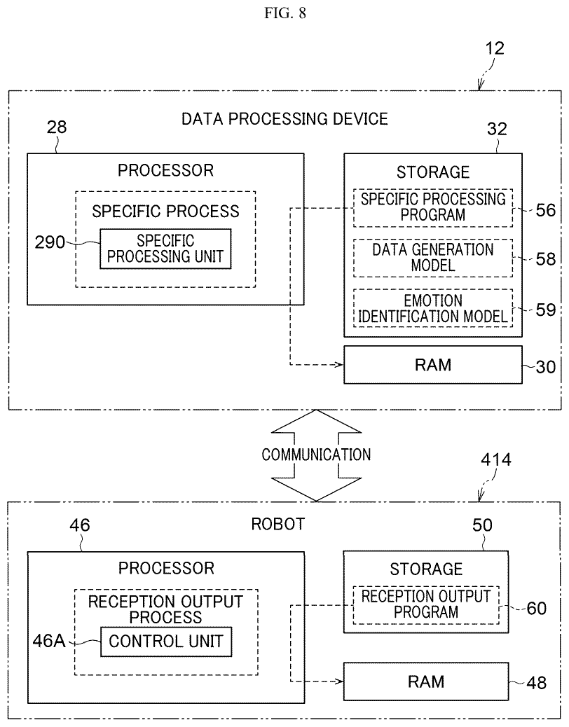

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

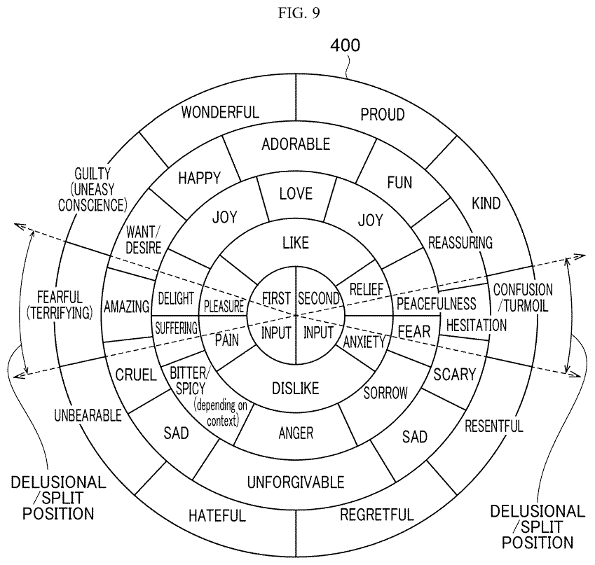

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

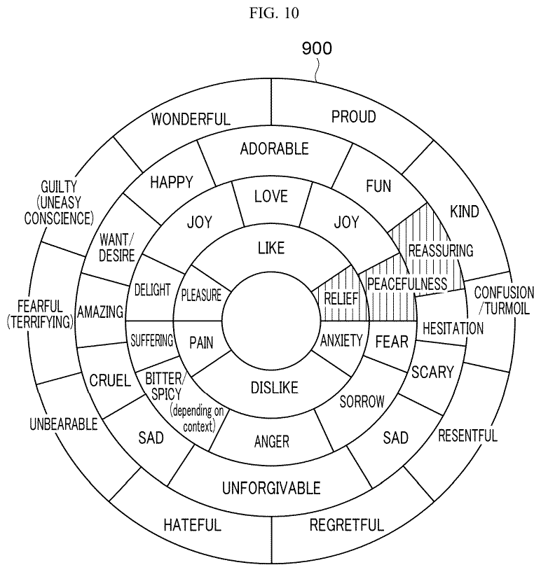

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a terminal, a work instruction expressed in natural language from a user, and store the work instruction in a data storage; and
analyze the received work instruction to generate, based on an analysis result, a first prompt sentence that instructs a generative AI model to convert the work instruction into structured task information representing at least one work task; and
transmit the first prompt sentence to the generative AI model via a communication interface, and obtain the structured task information generated by the generative AI model in response to the first prompt sentence; and
acquire schedule information from a time management information processing resource, by using the structured task information as input, and extract meeting information and participant information from the schedule information; and
generate, based on the meeting information and the participant information, a second prompt sentence that instructs the generative AI model to generate a meeting invitation communication text, and transmit the second prompt sentence to the generative AI model to obtain a draft of the meeting invitation communication text generated by the generative AI model; and
cause, by using a communication processing information resource, transmission of a meeting invitation communication to the participants on the basis of the draft of the meeting invitation communication text, and store a transmission result in the data storage; and
generate, based on the transmission result, result information that represents in natural language a summary of work processing executed by the system, and cause the result information to be presented on the terminal.

### Supplementary 2

The system according to supplementary 1,
wherein the processor is configured to
when the structured task information includes a plurality of work tasks, determine an execution order of the plurality of work tasks based on at least one of an importance level and an urgency level of each of the plurality of work tasks, and control the time management information processing resource and the communication processing information resource according to the determined execution order to automatically execute the plurality of work tasks.

### Supplementary 3

The system according to supplementary 1,
wherein the processor is configured to
cause the draft of the meeting invitation communication text generated by the generative AI model to be presented on the terminal in an editable format, receive a modification input for the draft of the meeting invitation communication text from the user via the terminal, and, after the modification input is reflected, cause a modified communication text to be transmitted via the communication processing information resource.

### Application Example 1

### Supplementary 1

A system comprising a processor,
wherein the processor is configured to
allocate, in a storage device, an individual generative AI model corresponding to each user and perform information processing using the generative AI model,
receive text data including a natural language instruction from a terminal of a user and generate a prompt sentence for input to the generative AI model based on the text data,
transmit the prompt sentence to the generative AI model and obtain a generation result including at least one of a task execution plan or a response draft corresponding to content of the instruction output by the generative AI model,
acquire, based on the generation result, work-related data including at least one of schedule information or inventory information from a real-time database, and extract or organize the work-related data in accordance with the content of the instruction, and
generate information presentable to the user based on the extracted or organized work-related data and the generation result, and transmit the information to the terminal.

### Supplementary 2

The system according to supplementary 1,
wherein the processor is configured to
control an operation condition of the generative AI model based on at least one of attribute information of the user or past interaction history of the user when generating the prompt sentence, and adjust the prompt sentence so that the generation result output by the generative AI model contributes to improvement of work efficiency of the user and reduction of psychological burden of the user.

### Supplementary 3

The system according to supplementary 1,
wherein the processor is configured to
provide, to the terminal, data in a format allowing manual editing or addition, the data including the generation result output by the generative AI model and the work-related data acquired from the real-time database, and enable the user to modify or confirm the generation result at the terminal.

### Example 2

### Supplementary 1

A system comprising a processor,
wherein the processor is configured to
receive communication information from a user,
analyze the communication information to generate a prompt sentence for causing a generative AI model to generate reply text information and work support operations related to the reply text information,
input the prompt sentence into the generative AI model and obtain structured information including contents of the reply text information and contents of the work support operations and an execution order of the work support operations,
determine priorities of a plurality of the work support operations including a time-recording process, a condition-checking process, a communication-information-checking process, and a schedule-adjusting process, based on the structured information, and automatically execute each of the work support operations according to the determined priorities via a communication interface of an external information processing service, and
present the reply text information generated by the generative AI model to an education terminal in an editable format.

### Supplementary 2

The system according to supplementary 1,
wherein the processor is configured to
control input information to the generative AI model by adding emotion state information, estimated from the communication information, at a time of generating the prompt sentence such that the reply text information generated by the generative AI model includes contents that increase a sense of security and a sense of trust of the user, and use the emotion state information and execution result information of the work support operations as additional input to the generative AI model so as to adaptively update subsequent reply text information and subsequent work support operations.

### Supplementary 3

The system according to supplementary 1,
wherein the processor is configured to
automatically determine the contents of the work support operations and the execution order of the work support operations based on a natural-language prompt sentence designated by the user, record a correspondence between the prompt sentence and an output of the generative AI model, and, for a later prompt sentence, estimate and propose contents of similar work support operations and a similar execution order so as to shorten work processing time and maximize communication effectiveness and work efficiency.

### Application Example 2

### Supplementary 1

A system comprising a processor,
wherein the processor is configured to
receive communication content from a guardian terminal via a communication network,
analyze the communication content by natural language processing and, based on an analysis result and attribute information or situation information related to a guardian, generate prompt data including a prompt sentence that defines a creation policy and a writing style for a reply draft,
input the prompt data to a generative AI model disposed internally or externally with respect to the system via the communication network and obtain generated text including the reply draft from the generative AI model,
convert the generated text into an editable display format for a teacher terminal and present the converted generated text to the teacher terminal, and
acquire an editing result from the teacher terminal and, as reply data corresponding to the communication content, associate the editing result with transmission management information, record the associated data, and transmit the reply data to the guardian terminal via a predetermined communication path.

### Supplementary 2

The system according to supplementary 1,
wherein the processor is configured to
perform emotion estimation processing on the communication content to specify an emotional state of the guardian when generating the prompt data, and control the prompt sentence so as to include, in accordance with the emotional state, an expression policy, a level of explanation detail, and a proposal content that are aimed at increasing a sense of security or a degree of trust of the guardian.

### Supplementary 3

The system according to supplementary 1,
wherein the processor is configured to
compare a plurality of reply candidates included in the generated text received from the generative AI model based on an evaluation index, assign priorities to the plurality of reply candidates based on at least one score relating to working-time reduction, readability, or emotional suitability, and change an order or an emphasis degree of presentation of the reply candidates on the teacher terminal in accordance with the assigned priorities.

What is claimed is:

1. A system comprising:
circuitry configured to:
receive, via a communication interface coupled to a packet-switched network, text data from a first terminal device;
perform natural language processing on the text data to generate a linguistic feature set including token sequences, syntactic structure data, and sentence-level feature vectors;
apply the sentence-level feature vectors to an emotion classification neural network comprising a plurality of attention layers and a classification output layer to generate affective state data including probability scores over a plurality of emotion categories;
generate an instruction sequence based on the linguistic feature set and the affective state data, the instruction sequence specifying creation constraints and expression parameters derived from the probability scores, and input the instruction sequence into a generative neural network model to cause the generative neural network model to generate structured output data including a plurality of candidate response segments;
compute, for each candidate response segment of the plurality of candidate response segments, an evaluation score based on at least one evaluation metric, and assign a priority value to each candidate response segment based on the evaluation score; and
generate presentation data including the plurality of candidate response segments arranged according to the assigned priority values in an editable data format, and transmit the presentation data to a second terminal device via the communication interface.

2. The system according to claim 1, wherein the circuitry is further configured to:
perform the natural language processing by executing tokenization to segment the text data into token sequences, sentence segmentation to identify sentence boundaries, part-of-speech tagging to assign grammatical category labels to each token, and dependency parsing to determine syntactic dependency relations among the tokens.

3. The system according to claim 2, wherein the circuitry is further configured to:
generate the sentence-level feature vectors by inputting the token sequences into a sentence encoder neural network that applies embedding operations and pooling operations to produce dense vector representations for each sentence in the text data.

4. The system according to claim 3, wherein the circuitry is further configured to:
generate the affective state data by computing, via the classification output layer comprising a softmax function, the probability scores over the plurality of emotion categories including at least an anxious category, a concerned category, a satisfied category, and a neutral category, and select a dominant emotion category having a highest probability score among the plurality of emotion categories.

5. The system according to claim 4, wherein the circuitry is further configured to:
map the dominant emotion category and the probability scores to expression policy parameters including an empathy level parameter, an explanation detail level parameter, and a proposal content constraint parameter, and incorporate the expression policy parameters into the instruction sequence as the creation constraints.

6. The system according to claim 1, wherein the circuitry is further configured to:
generate the instruction sequence by concatenating a system instruction portion specifying a generation role and a target tone, a content portion including the text data, and a format constraint portion that requires the generative neural network model to output the structured output data with predefined delimiters separating the plurality of candidate response segments.

7. The system according to claim 6, wherein:
the generative neural network model comprises a transformer-based neural network including a multi-layer self-attention architecture with multi-head attention sublayers and feed-forward sublayers, and the circuitry is configured to control decoding of the generative neural network model using a beam search algorithm with a temperature parameter and a maximum output length parameter stored in a configuration associated with a user of the first terminal device.

8. The system according to claim 7, wherein the circuitry is further configured to:
parse the structured output data by detecting delimiter patterns or tag markers in an output token sequence of the generative neural network model, and segment the output token sequence into the plurality of candidate response segments and associated parameter fields.

9. The system according to claim 1, wherein the circuitry is further configured to:
compute the evaluation score for each candidate response segment by determining a readability score based on average sentence length and vocabulary complexity of the candidate response segment, and an emotional suitability score by applying the emotion classification neural network to the candidate response segment and comparing a resulting emotion classification output to a target emotional tone derived from the affective state data.

10. The system according to claim 9, wherein the circuitry is further configured to:
compute a composite priority score for each candidate response segment as a weighted combination of the readability score and the emotional suitability score using weighting coefficients stored in a configuration table, and rank the plurality of candidate response segments according to the composite priority scores.

11. The system according to claim 10, wherein the circuitry is further configured to:
arrange, in the presentation data, a highest-ranked candidate response segment in a primary editable display area and remaining candidate response segments in collapsible display sections, and apply visual emphasis attributes to the highest-ranked candidate response segment based on the assigned priority values.

12. The system according to claim 1, wherein the circuitry is further configured to:
extract, from the structured output data, operation descriptor data indicating a plurality of auxiliary processing operations and execution order indices associated with each auxiliary processing operation, and determine execution priorities of the plurality of auxiliary processing operations by comparing task type identifiers of the auxiliary processing operations against a priority mapping table.

13. The system according to claim 12, wherein the circuitry is further configured to:
automatically execute each of the plurality of auxiliary processing operations according to the determined execution priorities via external information processing services accessible through the communication interface, the plurality of auxiliary processing operations including at least a time-recording process, a condition-checking process, a communication-information-checking process, and a schedule-adjusting process, and store execution result information indicating success or failure status for each auxiliary processing operation in a data storage.

14. The system according to claim 1, wherein the circuitry is further configured to:
use execution result information of previously executed auxiliary processing operations and the affective state data as additional context input to the generative neural network model when generating a subsequent instruction sequence, so as to adaptively update subsequent candidate response segments to reflect completed operations and the estimated emotional condition.

15. The system according to claim 14, wherein the circuitry is further configured to:
record a correspondence between each instruction sequence and a corresponding structured output data generated by the generative neural network model in a mapping table, compute a vector embedding of a new instruction sequence using a sentence encoder, compare the vector embedding to stored vector embeddings in the mapping table using a similarity metric, and, when a similarity score exceeds a threshold, retrieve a previously stored structured output data as a template to reduce inference computation by the generative neural network model.

16. The system according to claim 1, wherein the circuitry is further configured to:
acquire attribute information of a sender associated with the text data, the attribute information including at least one of a role, an interaction history, or a preference parameter, and acquire situation information including at least one of a conversation history or prior sentiment scores associated with the sender, and adjust the instruction sequence based on the attribute information and the situation information.

17. The system according to claim 16, wherein:
the text data comprises communication notebook content transmitted from a guardian of a student enrolled in an educational institution, the second terminal device is a teacher terminal operated by a teacher at the educational institution, the candidate response segments comprise draft reply text for responding to the guardian via a school communication platform, and the creation constraints specified in the instruction sequence are configured to cause the generative neural network model to generate the draft reply text including content that increases reassurance and a degree of trust of the guardian.

18. A system comprising:
circuitry configured to:
receive, via a communication interface coupled to a packet-switched network, text data from a first terminal device, the text data including a character string and a sender identifier;
perform tokenization and syntactic parsing on the text data to generate a linguistic feature set, and apply the linguistic feature set to an emotion classification neural network comprising a transformer-based encoder with a plurality of attention layers followed by a classification head layer to generate affective state data including probability scores and a dominant emotion category;
generate an instruction sequence by concatenating a system instruction portion specifying a creation policy and a writing style, a content portion including the text data, an emotion annotation portion including the dominant emotion category, and a format constraint portion requiring output of a plurality of candidate response segments with delimiter markers, and input the instruction sequence into a generative neural network model comprising a transformer-based architecture with multi-head self-attention sublayers to cause the generative neural network model to generate structured output data;
parse the structured output data to extract the plurality of candidate response segments, compute for each candidate response segment an evaluation score including a readability component and an emotional suitability component, and assign a priority value based on a weighted combination of the evaluation score components; and
generate presentation data arranging the plurality of candidate response segments according to the assigned priority values with a highest-priority candidate response segment in a primary editable display region, and transmit the presentation data to a second terminal device via the communication interface.

19. The system according to claim 18, wherein the circuitry is further configured to:
allocate, in a storage device, an individual generative neural network model configuration corresponding to each user identified by the sender identifier, the individual configuration including user-specific decoding parameters comprising a temperature parameter and output format constraints, and generate the instruction sequence using the individual configuration such that the structured output data is adapted to interaction patterns of the user.

20. A method performed by circuitry of a system, the method comprising:
receiving, via a communication interface coupled to a packet-switched network, text data from a first terminal device;
performing natural language processing on the text data to generate a linguistic feature set including token sequences, syntactic structure data, and sentence-level feature vectors;
applying the sentence-level feature vectors to an emotion classification neural network comprising a plurality of attention layers and a classification output layer to generate affective state data including probability scores over a plurality of emotion categories;
generating an instruction sequence based on the linguistic feature set and the affective state data, the instruction sequence specifying creation constraints and expression parameters derived from the probability scores, and inputting the instruction sequence into a generative neural network model to cause the generative neural network model to generate structured output data including a plurality of candidate response segments;
computing, for each candidate response segment of the plurality of candidate response segments, an evaluation score based on at least one evaluation metric, and assigning a priority value to each candidate response segment based on the evaluation score; and
generating presentation data including the plurality of candidate response segments arranged according to the assigned priority values in an editable data format, and transmitting the presentation data to a second terminal device via the communication interface.
